(19) United States
(12) Patent Application Publication
(10) Pub. No.: US 2005/0139110 A1
(43) Pub. Date: Jun. 30, 2005

(54) Method for regenerating lithographic printing plate, regenerating device, printer, lithographic printing plate and its production method, and layered structure body and its production method

(76) Inventors: Yasuharu Suda, Hiroshima-ken (JP); Hideaki Sakurai, Hiroshima-ken (JP); Toyoaki Yasui, Hiroshima-ken (JP); Toyoshi Ohto, Hiroshima-ken (JP)

Correspondence Address: ARMSTRONG, KRATZ, QUINTOS, HANSON & BROOKS, LLP, 1725 K STREET, NW, SUITE 1000, WASHINGTON, DC, 20006, US

(21) Appl. No.: 10/507,686

(22) PCT Filed: Mar. 19, 2003
(86) PCT No.: PCT/JP03/03361

(30) Foreign Application Priority Data
Mar. 23, 2002 (JP) 2002-81844
Aug. 2, 2002 (JP) 2002-226540

(51) Int. Cl. B41N 1/14

(52) U.S. Cl. 101/478

(57) ABSTRACT

The present invention relates to a method of regenerating a printing plate, a regenerating apparatus, and a printing press which make it possible to regenerate a printing plate for repetitive use and shorten the time of plate regeneration. In particular, the present invention intends to make it possible to shorten a time for decomposing and removing an image area formed with an organic compound under irradiation of an activating light. Furthermore, the present invention relates to a printing plate, a method of fabricating the printing plate, a layered formation, and a method of fabricating the layered formation. The present invention is arranged to include a photosensitive layer containing a photocatalyst and when the photosensitive layer is applied on the surface thereof with an activating light having an energy level higher than the band gap energy of the photocatalyst under a heating atmosphere, the surface of the photosensitive layer can be swiftly hydrophilized.

### TECHNICAL FIELD

The present invention relates to a method of regenerating a printing plate which can be regenerated for reuse, a regenerating apparatus, and a printing press. Moreover, the present invention relates to a printing plate and a method of fabricating the printing plate, a layered formation and a method of fabricating the layered formation.

### BACKGROUND ART

In the field of printing technology in general, digitization of printing process has recently been in progress. This technology involves creation of images and documents or manuscripts in digitized form on a personal computer or reading images on a scanner to digitize the image data and directly making a printing plate based on the digital data thus obtained. This allows labor-saving in the whole printing process and facilitates high precession printing.

According to a conventional manner, there has been generally used as a plate for use in printing a so-called PS plate (Presensitized Plate) which has anodized aluminum as a hydrophilic non-image area and a hydrophobic image area formed by curing a light sensitive resin on a surface of the non-image area. To prepare a printing plate using the PS plate, a plurality of steps are necessary, so that making of plates takes a long period of time and incurs high costs. Therefore, currently it is difficult to promote a reduction in time of printing process and a reduction in cost of printing. In particular, this is a major factor of an increase in printing costs in the cases of making a small number of print copies. Furthermore, when printing is executed with the PS plates, a developing process using developer is necessary, which makes the process of printing more cumbersome, and treatment after using the developer is an important task in view of an environmental contamination prevention.

Further, when printing is executed with the PS plate method, in general, a film having an original image provided thereon is brought to intimate contact to a plate surface and then brought to a light exposure. Therefore, if a user intends to fabricate the printing plate directly from the digital data and proceed the digitization of the printing process, the fabrication step of the printing plate is a hindrance factor. Furthermore, When printing of one picture pattern is completed, the plate has to be exchanged by anew one before next printing is performed and the used plates have been disposed.

To obviate the above disadvantages with PS plates, several methods have been proposed to facilitate preparation of printing plates in accordance with the digitization of printing process, and some of them have been commercialized. For example, Japanese Patent Laid-open (Kokai) No. Sho 63-102936 discloses a method of making a plate characterized in that an ink containing a photosensitive resin is utilized as an ink for a liquid ink-jet printing press, this ink is jetted toward a printing plate, and thereafter a light ray irradiation is effected to cure the image area. Further, Japanese Patent Laid-open (Kokai) No. Hei 11-254633 discloses a method of fabricating a color offset printing plate using an ink-jet head capable of spouting a solid ink.

Further, there are known several methods. One of them is a method which comprises providing a PET (polyethylene terephthalate) film having coated thereon a laser absorbing layer such as a carbon black layer and a silicon resin layer in order and image-wise irradiating the film with laser light to generate heat in the laser absorbing layer to burn off the silicone resin layer by the heat to prepare a printing plate. There is also known a method which comprises coating an oleophilic laser absorbing layer on an aluminum plate and a hydrophilic layer on the oleophilic laser absorbing layer and irradiating the hydrophilic layer with laser light to burn it off to make a printing plate.

One of other methods proposed is one in which a hydrophilic polymer is utilized as a printing plate, and an irradiation portion is subjected to an image-wise light exposure so that the irradiation portion is made into oleophilic and the plate making is completed.

Further, there is proposed a method in which an image is directly drawn with light from digital data to the PS plate. For example, an apparatus for writing an image by using a blue laser having a wavelength of 405 nm, an apparatus for writing an image by using a micro-mirror and a UV lamp, or so called CTP (Computer To Plate) can be commercially available.

Although these methods allow preparation of printing plates directly based on digital data, in these methods, when the printing of one picture pattern is over, the printing plate must be exchanged by a new one before the next printing can be performed. Therefore, printing plates once used must be disposed.

By contrast, technologies including a step of regenerating a plate have been proposed. For example, according to Japanese Patent Laid-open (Kokai) No. Hei 10-250027, there are disclosed a latent image block copy using a titanium dioxide photocatalyst, a method of fabricating the latent image block copy, and a printing apparatus having the latent image block copy. Further, according to Japanese Patent Laid-open (Kokai) No. Hei 11-147360, there is disclosed a method of carrying out offset printing using a printing plate with a photocatalyst. The above proposed methods include a step of irradiating light, that is, substantially an ultraviolet light, which can activate the photocatalyst upon writing an image, and a heat treatment is effected to hydrophobize the photocatalyst so as to regenerate the plate. Further, according to Japanese Patent Laid-open (Kokai) No. Hei 11-105234, there is proposed a method of writing an image area in such a manner that the photocatalyst is hydrophilized by the activating light, or the ultraviolet light, and thereafter an image area is written by a heat mode drawing.

However, Fujishima and Hashimoto, Professors of Tokyo University, confirmed that a titanium dioxide photocatalyst could be hydrophilized by a heat treatment [Minabe et al, “Study of photo-induced hydrophilic conversion on the TiO₂ surfaces involved by structural conformation thereof”, material of the 5th symposium of the photo functionalized Materials society, “Recent Deployment of Photocatalyst Reaction” (1998) p. 124 to 125]. According to the above material, the above-introduced methods disclosed in the respective Patent Publications could not be useful in regenerating the plate. In other words, to hydrophobize the photocatalyst by heat treatment is not useful for regenerating the plate. Thus, it is impossible to regenerate and reuse the plate or to fabricate the same by these methods.

Conversely, the inventors. of the present invention aggressively studied on a printing plate making it possible to write an image onto the printing plate by using a writing apparatus which employed the aforementioned activating light, light having a wavelength longer than the activating light, or an inactivating light, and after printing process being completed, to regenerate the plate swiftly for reuse of the printing plate. The inventors of the present invention also aggressively studied on a method of fabricating such a printing plate and a method of regenerating the same.

As a consequence, the inventors established a technology including a step of coating an organic compound which could hydrophobize the surface of the plate in order for regenerating the plate (or printing plate). In this case, it is a problem to establish a way to swiftly proceed the step of decomposing the organic material contained in the photocatalyst under an activating light irradiation during the process of regenerating the plate.

Meanwhile, in Japanese Patent Laid-open (Kokai) No. 2000-6360, there is disclosed a technology in which when a printing process is completed using a printing plate, an activating light mainly composed of ultraviolet ray is irradiated onto a layer containing a photocatalyst to erase an image. However, it took a long period of time to erase the image by only the irradiation of the activating light.

Further, in Japanese Patent Laid-open (Kokai) No. 2002-1900, there is disclosed a technology in which if the hydrophilic/oleophilic material provided on the surface of the printing plate is a photo-thermal converting material, a thermal irradiation such as an infrared ray irradiation is effected to delete the image. It is true that the disclosure contains a matter that if the hydrophilic/oleophilic material is a metal compound having a photocatalyst property (i.e., a hydrophilic/oleophilic material analogous to the photosensitive layer of the present invention) then an activating light is irradiated onto the entire surface thereof to delete the image. However, there is no implication about a combination of the activating ray irradiation and heat application contained therein.

On the other hand, there have been proposed technologies in which a photocatalyst is made to cohabit with silica or silicon so that the plate surface can exhibit a highly hydrophilic nature, or the hydrophilic nature can be maintained for a long period of time.

For example, Japanese Patent Publication Official Gazette No. 2756474 discloses a compound material composed of a substrate bonded on the surface thereof with a photocatalyst-made coating film containing a photocatalyst such as titanium oxide and silica. The above Official Gazette also discloses a compound material composed of a substrate bonded on the surface thereof with photocatalyst-made coating film composed of silicon having a photocatalyst material particles uniformly dispersed therein. This compound materials have a characteristic nature that when the compound materials are hydrophilized by optically energizing means, a satisfactory hydrophilic nature can be maintained on the surface of the compound material for a long period of time under a room-faint-illumination or a dark place.

Japanese Patent Publication Official Gazette No. 3077199 discloses a compound having a substrate coated on the surface with a material composed of a photocatalyst particles such as those of titanium oxide, silica minute particles and a precursor of silica or silicon, and hydrophilized by optically energizing means. This compound has a characteristic nature making the surface highly hydrophilic and maintaining the hydrophilic nature.

Also, Japanese Patent Publication Official Gazette No. 3087682 discloses a hydrophilic member having a photocatalyst nature composed of a substrate having on the surface thereof a layer containing an oxide material with a photocatalyst nature such as titanium oxide by way of an acryl silicon resin layer, or a layer containing an oxide material with a photocatalyst nature and silica, or a layer containing an oxide material with a photocatalyst nature and silicone. This hydrophilic member has a characteristic that it exhibits a highly hydrophilic nature in response to optical energizing means, and the surface layer thereof is firmly fixed to the substrate.

Also, there can be found a material disclosing a relation between the photocatalyst performance and the ambient temperature. For example, Japanese Patent Laid-open (Kokai) No. 2002-79774 discloses a method of printing, an original plate and an apparatus implementing the method thereof in which an advantage is taken from a unique temperature dependency on a rate or a changing degree of polarity conversion in a “material having a photocatalyst performance” so as to improve sensibility and discernibleness.

More concrete description is as follows. That is, an original printing plate having a photocatalyst performance is uniformly coated with a layer of hydrophobic substance, and thereafter the above original plate is subjected to a heat application at a temperature of 40° C. to 200° C. and an activating light irradiation. Thus, an image-wise distribution composed of a hydrophilic area and a hydrophobic area is formed on the plate. That is, FIG. 1 of the above publication represents a result of measurement under condition that an ultraviolet light having an energy intensity of 1.3 mW/cm² (activating light) is irradiated onto the surface of the titanium dioxide, and measurement is made on a time period required for the water contact angle on the surface to become 5°. Study of this figure reveals that it takes about 280 sec. for the hydrophilic nature to reach that level under an ordinary (room) temperature, but the time period required for the hydrophilic nature to reach that level is shortened to about 100 sec. if the plate is placed under an ambient at a temperature of 60° C. As described above, the above publication discloses that the rate of progress in hydrophilic nature can be enhanced by taking advantage of the temperature effect.

Also, the above publication discloses TiO₂, RTiO₃, AB₂₋ₓCₓD₃₋ₓEₓO₁₀, SnO₂, ZrO₂, Bi₂O₃, ZnO, and FeOₓ, as substances having the photocatalyst performance. Further, the above publication discloses a thermal insulating layer provided between a layer having the photocatalyst performance and a supporting body. As the thermal insulating layer, binding material selected from an organic macromolecular material and inorganic sol-gel converting material is also disclosed.

During the study concerning an image writing and image deleting on the printing plate having a layered formation containing a photocatalyst, the inventors confirmed that when the image writing was done with an activating light having an illuminance high enough to obtain an image writing rate at a practical level, the temperature at the plate surface was increased. Further, the inventors confirmed that if an original plate for printing having an arrangement similar to that disclosed in the above Japanese Patent Laid-open (Kokai) No. 2002-79774 was placed in the above-described temperature increasing condition of the plate surface, the hydrophilizing function of the photocatalyst could not be necessarily improved owing to the activating ray irradiation under the heat application environment. In some cases, the hydrophilizing function of the photocatalyst was rather lowered.

The present invention intends to solve the above problems. Therefore, it is an object of the present invention to provide a method of regenerating a printing plate, a regenerating apparatus, a printing press which makes it possible to regenerate the printing plate for repetitive use and shorten a time period required for regenerating the plate, particularly, a time period required for decomposing and removing an organic compound which constitutes an image area under an activating light irradiation.

Another object of the present invention is to provide a printing plate, a method of fabricating the printing plate, a layered formation, and a method of fabricating the formation in which, under heating atmosphere, an activating light having an energy higher than the band gap energy of the photocatalyst is irradiated onto the photosensitive layer so that the surface of the photosensitive layer can be swiftly hydrophilized.

### DISCLOSURE OF THE INVENTION

In order to solve the above problems, the present invention has taken the following countermeasures.

That is, according to the present invention, there is provided a method of regenerating a printing plate allowing reuse of the printing plate, the printing plate including a substrate, a photosensitive layer provided on a surface of the substrate and containing photocatalyst exhibiting hydrophilicity in response to an irradiation of an activating light with an energy level higher than the band gap energy, and a hydrophobic image area provided on a surface of the photosensitive layer and having an ink accepting property, wherein the method of regenerating a printing plate is characterized by including steps of removing ink attached to the surface of the photosensitive layer, deleting an image of the surface of the photosensitive layer in such a manner that the activating light is irradiated onto the surface of the photosensitive layer having the ink removed therefrom in the step of removing ink and the photosensitive layer is heated so as to make the entire surface of the photosensitive layer hydrophilic, and applying organic compound onto the surface of the photosensitive layer having the image deleted in the step of deleting the image.

In the step of deleting the image, the printing printing plate is irradiated on the printing plate surface thereof with the photocatalyst activating light to decompose the hydrophobic image area on the surface of the photosensitive layer, and at the same time, the surface of the photosensitive layer is converted into a hydrophilic nature, whereby the image is deleted. At this time, the image area decomposition is promoted by heating the surface of the photosensitive layer.

In this way, in the step of removing the ink, the ink attached to the surface of the printing printing plate can be removed, in the step of deleting the image, the activating light is irradiated onto the surface of the photosensitive layer on the printing printing plate having the ink removed therefrom by the aforesaid ink removing step, and the surface of the photosensitive layer is heated to hydrophilize the whole surface of the photosensitive layer and delete the image on the surface of the photosensitive layer, and in the step of applying the organic compound, the organic compound is supplied to the surface of the photosensitive layer having the image deleted therefrom. Accordingly, the printing plate can be regenerated and repetitively utilized. Therefore, the amount of printing plate disposed after utilization can be remarkably reduced and the cost regarding the printing plate can be decreased. Moreover, since the photosensitive layer surface is heated under an activating light irradiation, the image deletion of the plate can be executed in a short period of time, with the result that it becomes possible to shorten the plate regeneration time.

In the step of applying the organic compound, it is preferable for the photosensitive layer to be supplied on the surface thereof with an organic compound which has a nature that the organic compound is decomposed in response to the activating light irradiation owing to the action of the photocatalyst and a nature that the organic compound hydrophobizes the surface of the photosensitive layer owing to the reaction and/or interaction with the surface of the photosensitive layer.

With the above arrangement, the non-image area of the photosensitive layer surface can be irradiated with the activating light and hydrophilized so that an image can be written thereon. That is, when the activating light for the photocatalyst is irradiated onto the surface of the photosensitive layer, the photocatalyst is activated to oxidize and decompose the organic compound placed on the surface of the photosensitive layer. At the same time, since the photocatalyst itself comes to have a hydrophilic nature, the irradiated portion of the photosensitive layer becomes hydrophilic. Thus, it becomes possible to form a hydrophilic area (non-image area) and a hydrophobic area (image area) on the surface of the photosensitive layer (printing plate surface).

In the step of applying the organic compound, it is preferable for the photosensitive layer to be supplied on the surface thereof with an organic compound which has a nature that the organic compound is decomposed in response to the activating light irradiation owing to the action of the photocatalyst and a nature that the organic compound melts by heat application to be formed into a film-like shape and hydrophobizes the surface of the photosensitive layer owing to the reaction and/or interaction with the surface of the photosensitive layer or fixing on the surface of the photosensitive layer.

As a way of the above heat application, it is preferable to carry out heat treatment by irradiating light having an energy level lower than the band gap energy of the photocatalyst, or an inactive light. Infrared light can be exemplified as an example of the “inactivating light”. Irradiation of such a kind of light will melt the organic compound without decomposing the same, form the compound into a film-like sheet, and effect reaction with and/or fixing on the photosensitive layer. Further, other arrangement can be employed as the way of heat application. For example, it is needless to say that a thermal head may be employed for applying heat directly on the organic compound coating surface.

With the above arrangement, after the organic compound is coated, if the inactivating light is irradiated on the surface of the photosensitive layer, for example, and the organic compound is melted and stuck on the surface of the photosensitive layer to hydrophobize the surface, the surface comes to have a hydrophobic image area at which an image can be written. Thereafter, at a stage soon after starting the printing, the organic compound on the non-image area is removed owing to the effect of ink viscosity and/or the cleaning effect of dampening water. That is, the hydrophilic photosensitive layer surface is exposed as a non-image area. In this way, it becomes possible to form a hydrophilic area (non-image area) and a hydrophobic area (image area) on the surface of the photosensitive layer (printing plate surface).

In the step of deleting the image, it is preferable for the surface of the photosensitive layer to be heated up to a temperature range of at least 50° C. and below 200° C. With this arrangement, the decomposing reaction on the organic compound owing to the action of the photocatalyst can be accelerated and the image on the plate can be deleted within a short period of time, with the result that it becomes possible to shorten the plate regeneration time.

It is preferable for the heating process in the step of deleting the image to be effected by applying hot air to the surface of the photosensitive layer. Alternatively, the heating process is preferably effected by irradiating light onto the surface of the photosensitive layer.

The activating light is preferably one having a wavelength of 600 nm or below. With this arrangement, the photocatalyst action can be activated on the photosensitive layer by using light having a wavelength smaller than that of visible light.

The photocatalyst is preferably a titanium dioxide photocatalyst or a visible light responsive type titanium dioxide photocatalyst.

Meanwhile, the term “visible light responsive type titanium dioxide photocatalyst” (reformed titanium dioxide photocatalyst) means a substance created based on a titanium dioxide photocatalyst having a metallic element or a non-metallic element other than elements originally contained in the titanium dioxide photocatalyst doped or held therein, or alternatively, a titanium dioxide photocatalyst composed of Ti element and O element at a ratio shifted from the stoichiometric ratio thereof, i.e., a ratio of Ti atoms to oxygen atoms, 1:2, and so on.

According to the present invention, there is provided a regenerating apparatus for use with a printing plate applied with the aforesaid hydrophilization promoting apparatus, characterized by including a plate cylinder having attached thereon a printing plate which includes a substrate and a photosensitive layer containing photocatalyst exhibiting a hydrophilic nature in response to an activating light with an energy level higher than the band gap energy, a plate cleaning unit for removing ink applied on the surface of the photosensitive layer, an image deleting unit for irradiating the activating light on the photosensitive layer so as to make the entire surface of the photosensitive layer hydrophilic and delete the image on the surface of the photosensitive layer, a heating unit for heating the surface of the photosensitive layer to promote the hydrophilization upon deleting the image, and an organic compound applying unit for applying an organic compound onto the surface of the photosensitive layer.

Accordingly, after the plate cleaning unit removes the ink coated on the surface of the printing plate attached to the plate cylinder, the image deleting unit irradiates the activating light onto the surface of the printing plate while the heating unit heats the surface of the printing plate, whereby the entire surface of the photosensitive layer is hydrophilized and the image formed on the surface of the photosensitive layer is deleted. Thereafter, the organic compound applying unit applies the organic compound to the surface of the photosensitive layer.

Thus, the printing plate can be regenerated and repetitively utilized. Therefore, it becomes possible to remarkably decrease the amount of printing plate disposed after utilization, and the cost regarding the printing plate can be reduced. Moreover, the activating light irradiation is effected onto the surface of the photosensitive layer to heat the same, making it possible to accelerate the photocatalyst activation to shorten the period of time required to delete the image on the plate. In this way, the plate regeneration time can be shortened.

It is preferable for the heating unit to heat the surface of the photosensitive layer by an electric heater. Alternatively, it is preferable for the same to heat the surface of the photosensitive layer by a light irradiation.

As a first arrangement of the regenerating apparatus, it is preferable for the organic compound applying unit to supply to the surface of the photosensitive layer an organic compound which has a nature that the organic compound is decomposed in response to the activating light irradiation owing to the action of the photocatalyst and a nature that the organic compound hydrophobizes the surface of the photosensitive layer owing to the reaction and/or interaction with the surface of the photosensitive layer.

The organic compound arranged as described above is applied to the surface of the photosensitive layer to hydrophobize the same and, in the imaging step, the activating light is irradiated thereon. Therefore, the organic compound can be decomposed simultaneously with the hydrophilization of the photosensitive layer. Thus, it becomes possible to fabricate a plate composed of a non-image area exhibiting the hydrophilic nature and an image area exhibiting the hydrophobic nature.

That is, a area of the surface converted to have the hydrophilic nature is attached with dampening water with priority, functioning as the non-image area on which the hydrophobic ink is prevented from attaching thereto. Conversely, an area of the plate surface protected from the activating light irradiation allows the reaction and/or interaction of the organic compound with the photosensitive layer surface, and hence the surface of the photosensitive layer is hydrophobized. Therefore, this area of the plate surface is attached with hydrophobic ink with priority, functioning as the image area on which the dampening water is prevented from attaching thereto.

As a consequence, the hydrophilic non-image area and hydrophobic image area can be created on the printing plate surface, and the printing plate can be utilized as a planographic printing plate.

As a second arrangement of the regenerating apparatus, it is preferable for the organic compound applying unit to supply to the surface of the photosensitive layer an organic compound which has a nature that the organic compound is decomposed in response to the activating light irradiation owing to the action of the photocatalyst and a nature that the organic compound melts by heating to be formed into a film-like shape and hydrophobizes the surface of the photosensitive layer owing to the reaction and/or interaction with the surface of the photosensitive layer or fixing on the surface of the photosensitive layer.

That is, after the organic compound is coated on the plate surface, for example, an inactivating light irradiation is effected on the surface of the photosensitive layer to heat the organic compound, melt and fix the same on the surface of the photosensitive layer, thus hydrophobizing the surface of the photosensitive layer. In this way, a hydrophobized image area can be written on the surface. Then, the hydrophobized image area tends to accept a hydrophobic ink with priority and repel the dampening water, functioning as an image area.

On the other hand, the organic compound on the printing plate surface having the inactivating light irradiated thereon can be removed from the plate surface simultaneously with the starting of printing owing to the dampening water or the viscosity of the ink. Thus, the hydrophilic photosensitive layer surface is exposed. Accordingly, this hydrophilic are a of the photosensitive layer surface tends to accept the dampening water with priority and repel the hydrophobic ink, functioning as an image area.

As a consequence, the hydrophilic non-image area and hydrophobic image area can be created on the printing plate surface, and the printing plate can be utilized as a planographic printing plate.

According to the present invention, there is provided a first printing press characterized by including a regenerating apparatus having the organic compound applying unit of the first arrangement, and an imaging unit for irradiating an activating light onto the surface of the photosensitive layer covered with a hydrophobic organic compound to decompose and remove the hydrophobic organic compound, exposing the surface of the hydrophilic photosensitive layer, and writing an image on the surface of the hydrophilic photosensitive layer.

Accordingly, the imaging unit can irradiate the activating light of the photocatalyst onto the photosensitive layer surface covered with the organic compound to decompose and remove the hydrophobic organic compound and expose the hydrophilic photosensitive layer surface so that the photosensitive layer surface comes to have formed an image (latent image) composed of a hydrophilic non-image area and a hydrophobic image area. Thus, an image can be again written on the printing plate which is regenerated by the regenerating apparatus.

According to the present invention, there is provided a second printing press characterized by including a regenerating apparatus having the organic compound applying unit of the second arrangement, and an imaging unit for irradiating an inactivating light for the photocatalyst so as to bring the image area into a reaction and/or an interaction with the surface of the photosensitive layer so that the organic compound is fixed thereon, whereby an image is written on the surface of the photosensitive layer.

Accordingly, the imaging unit heats the photosensitive layer surface covered with the organic compound so as to bring the photosensitive layer surface into the reaction and/or the interaction with the organic compound so that the organic compound is fixed thereon, whereby an image composed of a hydrophilic non-image area and a hydrophobic image area can be written. Thus, an image can be again written on the printing plate which is regenerated by the regenerating apparatus.

According to the present invention, there is provided a printing plate having a photosensitive layer containing a photocatalyst which makes it possible to carry out image writing and image deleting in response to irradiation of an activating light having an energy level higher than the band gap energy of said photocatalyst, thereby to regenerate the printing plate for allowing reuse of the printing plate, wherein a hydrophilization promoting layer for promoting hydrophilization is provided between a substrate and the photosensitive layer.

With the above arrangement, it becomes possible to create a high photocatalyst activation under the heated atmosphere, with the result that the photosensitive layer surface can be swiftly hydrophilized.

Accordingly, the time period required for the printing process can be shortened. In particular, it becomes possible to remarkably shorten the time period of the image writing and the time period of the image deleting, with the result that the printing preparation time can be shortened.

It is preferable for the hydrophilization promoting layer to contain a material having a water retaining property.

It is preferable for the material having the water retaining property to be composed of a silica compound.

It is preferable for the photocatalyst to be a titanium dioxide photocatalyst or a visible light responsive type titanium dioxide photocatalyst. With this arrangement, the image can be written with light having a wavelength of visible light to a wavelength of ultraviolet light.

It is preferable for the printing plate to have a nature that when the activating light is irradiated to effect image writing and image deleting, at least a part of the surface of the photosensitive layer is converted from a hydrophobic nature to a hydrophilic nature.

It is preferable for the activating light to be one having a wavelength of 600 nm or below.

It is preferable for the surface of the photosensitive layer to be hydrophobized by any of actions that a bundle of light beams or electric energy beams is solely or in combination fashion applied onto the surface of said photosensitive layer, friction is applied on the surface of the photosensitive layer, or that an organic compound capable of effecting interaction with the surface of the photosensitive layer is supplied to the surface of the photosensitive layer.

According to the present invention, there is proposed a method of fabricating a printing plate characterized by including a step of forming the hydrophilization promoting layer on the substrate and thereafter forming the photosensitive layer on the hydrophilization promoting layer.

According to the present invention, there is provided a layered formation having a photosensitive layer containing a photocatalyst, in which the layered formation exhibits simultaneously two performances, i.e., a performance making it possible to decompose an organic compound provided on the surface of the photosensitive layer in response to an irradiation of an activating light having an energy level higher than the band gap energy of the photocatalyst and a performance making it possible to hydrophilize the surface of the photosensitive layer, and a water retaining layer containing a material having a water retaining property is provided between a substrate and the photosensitive layer.

It is preferable for the material having the water retaining property to be a silica compound.

It is preferable for the photocatalyst to be a titanium dioxide photocatalyst or a visible light responsive type titanium dioxide photocatalyst.

According to the present invention, there is proposed a method of fabricating a layered formation characterized by including a step of forming the water retaining layer on the substrate and thereafter forming the photosensitive layer on the water retaining layer.

### BRIEF DESCRIPTION OF THE DRAWINGS

FIG. 1 is a schematic cross-sectional view showing a printing plate according to a first embodiment of the present invention in which the surface of the material exhibits a hydrophobic nature;

FIG. 2 is a schematic cross-sectional view showing a printing plate according to the first embodiment of the present invention in which the surface of the material exhibits a hydrophilic nature;

FIG. 3 is a set of schematic perspective views illustrating a cycle of from the image writing to the regeneration of the printing plate according to the first embodiment of the present invention;

FIG. 4 is a flowchart for explaining the fabrication and regeneration of the plate according to the first embodiment of the present invention;

FIG. 5 is a schematic perspective view showing one example of the printing plate according to the first embodiment of the present invention;

FIG. 6 is a graph showing a relationship between a heating temperature and a time period required for hydrophilization in the step of image deleting of the printing plate according to the first embodiment of the present invention;

FIG. 7 is a graph showing a relationship between the water contact angle on the printing plate surface and time periods (or respective operations) according to the first embodiment of the present invention;

FIG. 8 is a diagram schematically showing a printing press for carrying out printing and regeneration of the plate according to the first embodiment of the present invention;

FIG. 9 is a graph showing a relationship between the temperature of the plate surface and energy for hydrophilization in the step of image deleting of the printing plate according to the first embodiment of the present invention;

FIG. 10 is a schematic cross-sectional view showing a printing plate according to a second embodiment of the present invention in which the surface of the material exhibits a hydrophobic nature;

FIG. 11 is a schematic cross-sectional view showing a printing plate according to the second embodiment of the present invention in which the surface of the material exhibits a hydrophilic nature;

FIG. 12 is a set of schematic perspective views illustrating a cycle of from the image writing to the regeneration of the printing plate according to the second embodiment of the present invention;

FIG. 13 is a flowchart for explaining the fabrication of the plate according to the second embodiment of the present invention;

FIG. 14 is a schematic perspective view showing one example of the printing plate according to the second embodiment of the present invention;

FIG. 15 is a graph showing a relationship between the water contact angle on the printing plate surface and time periods (or respective operations) according to the second embodiment of the present invention;

FIG. 16 is a graph showing a relationship between the temperature of the plate surface and energy for hydrophilization in the step of image deleting of the printing plate according to the first embodiment of the present invention; and

FIG. 17 is a graph showing how the hydrophilizing energy varies relative to the surface temperature of a layered formation (printing plate) as a third embodiment of the present invention.

### BEST MODE FOR CARRYING OUT THE INVENTION

Embodiments of the present invention will be hereinafter described with reference to drawings.

### [1] FIRST EMBODIMENT

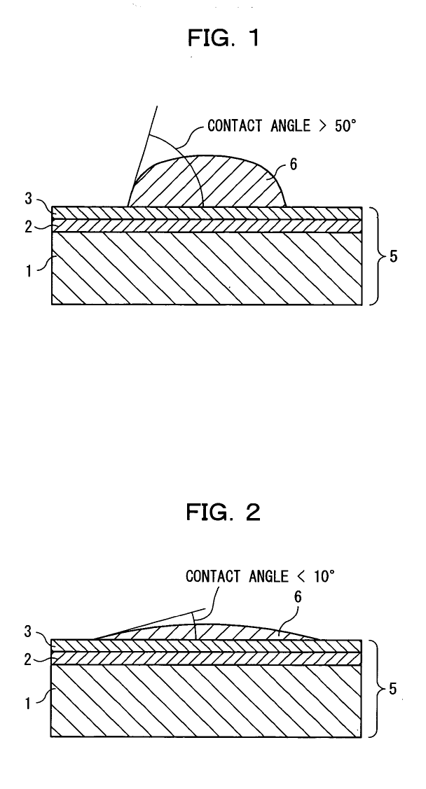

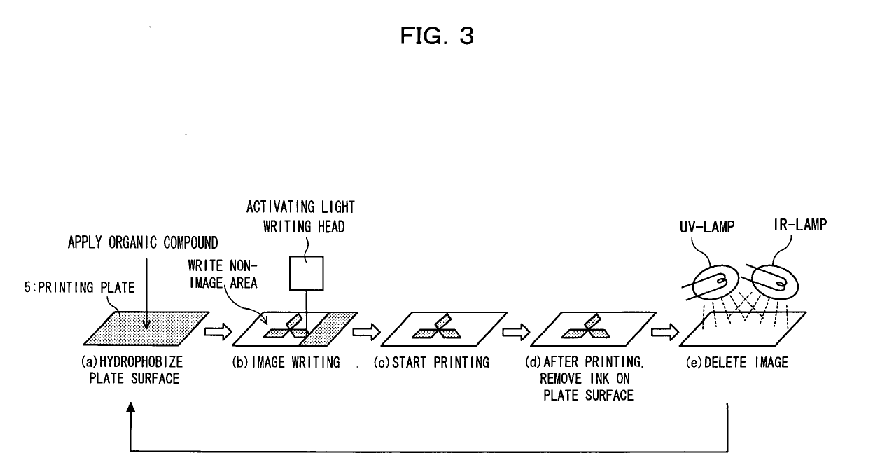

FIGS. 1 and 2 are diagrams showing a printing plate (layered formation) as a first embodiment of the present invention. FIG. 1 is a cross-sectional view showing a case in which the surface of the printing plate exhibits a hydrophobic nature while FIG. 2 is a cross-sectional view showing a case in which the surface of the printing plate exhibits a hydrophilic nature.

As shown in FIG. 1, a printing plate 5 is fundamentally composed of a substrate 1, an intermediate layer 2 and a photosensitive layer (photosensitive layer) 3. The printing plate may be simply referred to as a printing plate. Further, a printing plate having an image area formed on the surface thereof for printing is referred to as a plate.

The substrate 1 is composed of a metal such as aluminum, stainless steel, and polymer film or the like. However, the material therefore may not be limited to a metal such as aluminum, stainless steel, and polymer film.

The intermediate film 2 is formed on the surface of the substrate 1 so that the substrate 1 and the photosensitive layer 3, which will be described later on, can reliably adhere to each other. The intermediate film is also provided to improve intimate contact between them. However, if the substrate 1 and the photosensitive layer 3 can reliably adhere to each other without the intermediate layer, the intermediate layer 2 may be obviated. Further, the intermediate layer 2 may be provided depending on necessity for protecting the substrate 1 if the substrate 1 is formed of a polymer film or the like.

As a material for the intermediate layer 2, for example, silicon compound such as silica (SiO₂), silicon resin, silicon gum is employed. Of these materials, in particular, silicon alkyd resin, silicon urethane resin, silicon epoxy resin, silicon acrylic resin, silicon polyester resin and so on can be utilized as the silicon resin.

The intermediate layer 2 may be one enhancing the photocatalyst action of the photosensitive layer 3. As such intermediate layer 2, a layer containing a semiconductor or an electric conductive material can be utilized.

If a semiconductor is introduced into the intermediate layer, oxide semiconductor such as zinc oxide ZnO, tin oxide SnO₂, tungstic oxide WO₃ is preferable. Meanwhile, it is preferable to employ a method of forming the intermediate layer 2 of any of these semiconductors. But the intermediate layer 2 may be formed by other method such that semiconductor particles are bound together with other binder material and formed into a film-like component.

Further, if an electric conductive material is introduced, an oxide material such as ITO (oxide material of indium and tin), a metal such as aluminum, silver, copper or alternatively, carbon black, conductive polymer and soon can be employed. The intermediate layer 2 may be formed of these electric conductive materials themselves. Alternatively, particles of the electric conductive material may be formed into a film-like shape together with other binder material to provide the intermediate layer 2.

If the intermediate layer 2 containing the above-described semiconductors or the electric conductive materials is provided, then the writing rate upon image writing with an activating light can be increased to shorten the plate-making time. Further, optical energy required for the image writing can be decreased. Moreover, the irradiation energy of the activating light irradiated on the plate surface upon regenerating the plate in order for deleting (erasing) the image can be decreased. The reason therefor is assumed that the semiconductor or the electric conductive material composing the intermediate layer 2 enhances the function of the photocatalyst contained in the photosensitive layer 3 which will be described later on.

The intermediate layer 2 offers the following advantage. That is, when a heat treatment is effected to form the photosensitive layer 3, which will be described later on, impurity may intrude from the substrate 1 into the photosensitive layer 3 due to the thermal diffusion, leading to deterioration in the photocatalyst activation. However, owing to the intermediate layer, this deterioration in the photocatalyst activation can be prevented.

The photosensitive layer 3 contains a photocatalyst and formed on the surface of the intermediate layer 2. If the intermediate layer 2 is not formed on the surface of the substrate 1, it follows that the photosensitive layer 3 is directly formed on the surface of the substrate 1.

The surface of the photosensitive layer 3 is arranged to exhibit a high photocatalyst activity in response to an irradiation with an activating light having an energy level higher than the band gap energy of the photocatalyst. This nature comes from the nature possessed by the photocatalyst. FIG. 2 shows a state of the exposed photosensitive layer 3 which exhibits a hydrophilic nature owing to the activating light irradiation. Since the photosensitive layer 3 having the hydrophilic photocatalyst is exposed, it becomes possible to form a non-image area of the printing plate 5.

One of the features of the printing plate 5 as the present embodiment is that the photosensitive layer 3 formed thereon contains a photocatalyst responsive to light having a wavelength equal to or shorter than a visible light with a wavelength of 600 nm (i.e., the activating light is at least one of visible light with a wavelength of 400 nm to 600 nm and a ultraviolet light with a wavelength equal to or shorter than 400 nm). Since the photosensitive layer contains the above-described photocatalyst, if an activating light having a wavelength equal to or shorter than 600 nm is irradiated onto the surface of the photosensitive layer 3, the surface of the photosensitive layer 3 exhibits a high hydrophilic nature. Further, if an organic compound is coated on the surface of the photosensitive layer 3, for example, the irradiated light oxidizes and decomposes the organic compound. The organic compound will be more fully described later on.

The photocatalyst will not exhibit a photocatalyst activity until the irradiated light comes to have an energy level higher than the band gap energy. For example, since a titanium dioxide photocatalyst has a band gap energy as high as 3 eV, this photocatalyst will not respond to a ultraviolet light with a wavelength equal to or shorter than 400 nm.

According to the present invention, a new energy level is introduced into the band gap so that the photocatalyst can respond to an activating light with a wavelength equal to or shorter than 600 nm which contains a visible light with a wavelength longer than that of a ultraviolet light. Of course, the activating light with a wavelength equal to or shorter than 600 nm can contain a ultraviolet light, but the activating light may not necessarily contain a ultraviolet light. That is, the photocatalyst is arranged to respond to light containing only a visible light with a wavelength of about 600 nm to 400 nm in a similar manner.

The photocatalyst responsive to light residing in a visible region may be produced by a publicly known method. For example, Japanese Patent Laid-open (Kokai) No. 2001-207082 discloses a visible light responsive type titanium dioxide photocatalyst doped with nitrogen atoms. Further, Japanese Patent Laid-open (Kokai) No. 2001-205104 discloses a visible light responsive type titanium dioxide photocatalyst doped with chromium atoms and nitrogen atoms.

Furthermore, Japanese Patent Laid-open (Kokai) No. Hei 11-197512 discloses a visible light responsive type titanium dioxide photocatalyst having metal ions such as those of chromium ion-implanted. Information is available about other types of visible light responsive type titanium dioxide photocatalyst produced by using low-temperature plasma or visible light responsive type titanium dioxide photocatalyst holding a platinum atom.

When the printing plate 5 according to the present invention is fabricated, these kinds of so-called visible light responsive type photocatalyst produced by the publicly known methods [e.g., visible light responsive type titanium dioxide photocatalyst (modified titanium dioxide photocatalyst)] may be employed.

As the photocatalyst energized in response to the activating light with a wavelength equal to or shorter than 400 nm, any type of photocatalyst can be properly selected from commercially available ordinary types of titanium photocatalyst and employed.

As of the titanium dioxide photocatalyst, there are rutile-type one, anatase-type one, and brushite-type one. Any of these types can be employed in the present embodiment, and a mixture thereof can be employed. However, anatase-type one is preferable under consideration of the photocatalyst activity.

Further, as will be described later on, in order to improve the photocatalyst activity for decomposing the compound at the image area under the activating light irradiation, it is desirable for the titanium dioxide photocatalyst particles to have a somewhat small diameter. In more concretely, the titanium dioxide photocatalyst particles preferably have a diameter equal to or smaller than 0.1 μm, and more preferably, have a diameter equal to or smaller than 0.05 μm. As the photocatalyst, titanium dioxide photocatalyst is suitable. Of course, the photocatalyst is not limited thereto.

As for the titanium dioxide photocatalyst, specific examples thereof which are commercially available and can be used in the present embodiment include ST-01, ST-21, their processed products ST-K01 and ST-K03, water dispersed type STS-01, STS-02 and STS-21, all produced by Ishihara Sangyo Kaisha, Ltd.; SSP-25, SSP-20, SSP-M, CSB, and CSB-M and paint type LAC Tl-01, LAC Tl-03-A, produced by Sakai Chemical Industry Co., Ltd. As for the titanium oxide coating liquid for use with the photocatalyst, specific examples thereof include TKS-201, TKS-202, TKC-301, TKC-302, TKC-303, TKC-304, TKC-305, TKC-351, TKC-352, and specific examples of titanium oxide sol for use with photocatalyst include TKS-201, TKS-202, TKS-203, TKS-251, all of them produced by TAYCA Corporation, and PTA, TO, TPX and so on produced by ARITEKKUSU etc. However, it is needless to say that the present invention can be practiced with titanium dioxide photocatalysts other than the above.

It is preferred that the coat layer 3 have a thickness in the range of 0.005 to 1 μm. This is because too small a film thickness makes it difficult to utilize the above-described properties sufficiently whereas too large a film thickness tends to lead to cracking of the coat layer 3, thereby causing a decrease in durability. The cracking is observed frequently when the film thickness exceeds 10 μm, so that it is necessary to pay attention to that an upper limit of the film thickness is 10 μm. From the practical standpoint, it is preferable for the film thickness to be set to about 0.01 to 0.5 μm.

Further, as a method of forming the photosensitive layer 3, any method may be properly selected from sol-coating method, organotitanium method, vapor deposition method or the like to form the layer. At this time, if the sol-coating method is selected, for example, the sol-coating liquid employed therefor may be added with a solvent, a cross-linking agent, surfactant or the like in addition to the above respective materials which improve the strength of the titanium dioxide photocatalyst and the photosensitive layer 3 and the intimate adhesiveness between the substrate 1 and the photosensitive layer 3.

The sol coating liquid may be either of a room temperature drying type or of a heat drying type. It is more preferable to adopt the latter. This is because it is more advantageous for increasing the durability of the printing plate 5 in printing to increase the strength of the photosensitive layer 3 by heat application. Furthermore, the photosensitive layer 3 can be fabricated to have a higher strength by some methods. For example, an indeterminate titanium oxide layer may be developed on a metal substrate in a vacuum chamber by using a vapor deposition method or the like, and thereafter crystallization is taken place by effecting heat treatment so that the photosensitive layer having a large strength is fabricated.

In order for hydrophobizing the photosensitive layer 3, it is needless to say that the organic compound desirably has a function promoting a chemical reaction or strong interaction with at least a hydrophilic area of the printing plate 5 surface (surface for the plate) to cover the hydrophilic surface and converting the hydrophilic surface of the photosensitive layer 3 into hydrophobic one. At the same time, the organic compound desirably has a nature to be decomposed with ease owing to the action of oxidation and decomposition of the photocatalyst under the activating light irradiation.

The above-described types of organic compounds can be classified into two types depending on a system of writing.

The subject embodiment will be described based on a case in which one of the two types of organic compounds is utilized, that is, description will be made on a case in which one of the two writing systems is employed. As for the other writing system, description will be provided together with that of the second embodiment.

That is, the organic compound utilized in the present embodiment (type A) is supplied to the surface of the printing plate 5 and responds to merely the drying or heat drying depending on necessity to cause reaction and/or strong interaction with the surface of the photosensitive layer 3. Thus, the surface of the photosensitive layer 3 can be hydrophobized. Further, when the activating light is irradiated on the surface, the organic compound is decomposed owing to the action of the photocatalyst of the photosensitive layer 3, with the result that the compound can be removed from the surface of the photosensitive layer 3.

As for the above-described organic compound, specific preferable examples include organic titanium compound, organic silane compound, isocyanate type compound and epoxide type compound. Since these types of compounds can react with hydroxide group existing on the hydrophilic surface of the photosensitive layer 3 to be fixed on the surface, an organic compound layer of a monomolecular layer fashion (not shown) is formed on the surface of the photosensitive layer 3 in accordance with the principle thereof. In this way, hydrophobization is caused on the surface of the photosensitive layer 3 at the monomolecular layer, with the result that it becomes easy to decompose the compound under the activating light irradiation.

Examples of such organic titanium compounds are as follows. That is: 1) titanium alkoxides such as titanium tetraisopropoxide, titanium tetra-n-propoxide, titanium tetra-n-butoxide, and titanium tetraisobutoxide, titanium tetra stearoxide; 2) titanium acylates such as tri-n-butoxytitanium stearate and isopropoxytitanium tristearate; 3) titanium chelates such as diisopropoxytitanium bisacetylacetonate, dihydroxy bislactatotitanium, and isopropoxytitanium octylene glycol.

Examples of organic silane compounds are as follows. That is: 1) alkoxysilanes such as trimethylmethoxysilane, trimethylethoxysilane, dimethyldiethoxysilane, methyltrimethoxysilane, tetramethoxysilane, methyltriethoxysilane, tetramethoxysilane, methyldimethoxysilane, octadecyltrimethoxysilane, and octadecyltrimethoxysilane; 2) chlorosilanes such as trimethylchlorosilane, dimethyldichlorosilane, methyltrichlorosilane, methyldichlorosilane, and dimethylchlorosilane; 3) silane coupling agents such as vinyltrichlorosilane, vinyltriethoxysilane, γ-chloropropyltrimethoxysilane, γ-chloropropylmethyldichlorosilane, γ-chloropropylmethyldimethoxysilane, γ-chloropropylmethyldiethoxysilane, and γ-aminopropyltriethoxysilane; and 4) fluoroalkylsilane such as perfluoroalkyltrimethoxysilane.

Examples of isocyanate type compounds include dodecyl isocyanate, octadecyl isocyanate, and the like.

Further, examples of epoxide type compounds include 1,2-epoxy decane, 1,2-epoxy hexadecane, 1,2-epoxy octadecane and the like.

Organic titanium compounds, organic silane compounds, isocyanate type compounds, and epoxide type compounds are not limited to the above-listed substances.

If the compounds are in a liquid state in a room temperature, the above-listed organic compounds may be coated on the photosensitive layer 3 by a blade coating method, a roll coating method, a dip coating method or the like, or may be coated on the same by spraying with fine particles thereof. Further, the liquid may be heated for vaporization up to a temperature below one at which decomposition is brought about. Also, the liquid may be vaporized by a mist creating apparatus for a liquid using ultrasound, i.e., so-called a nebulizer. Thus, the liquid may be sprayed on the surface of the photosensitive layer 3. It is needless to say that the liquid may be diluted with other solvent for the purpose of adjusting the concentration, viscosity or the like of the organic compounds.

A method of fabricating the printing plate and a method of regenerating the same will be hereinafter described.

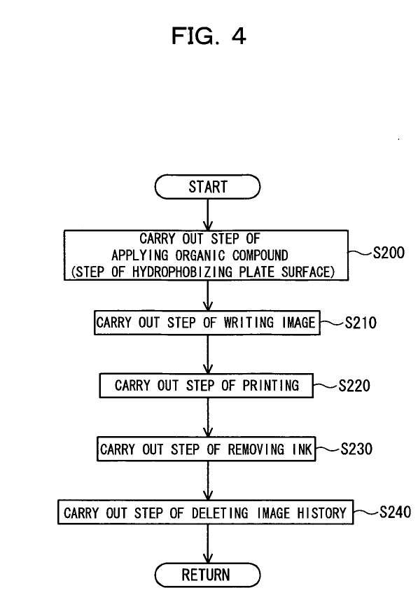

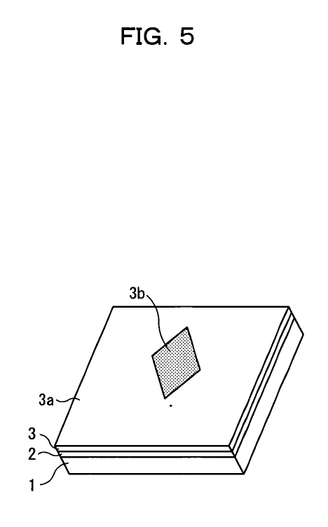

As shown in FIG. 4, the flow of fabrication and regeneration of the plate is arranged to include a step of applying organic compound (step of hydrophobizing the plate surface) (S200), a step of writing an image (S210), a step of printing (S220), a step of removing ink (S230), and a step of deleting image (S240).

Initially, description will be made on a method of fabricating the printing plate.

In the following description, a term “fabrication of plate” means to prepare a printing plate 5 of which surface (i.e., the surface of the photosensitive layer 3) is hydrophobized (initial state), to irradiate an activating light on at least a part of the surface of the printing plate 5 based on digital data to form a hydrophilic non-image area, and to form a latent image consisting of a hydrophobic image area and a hydrophilic non-image area on the surface of the printing plate 5 together with the hydrophobic area (i.e., image area) of the surface of the printing plate 5 on which no activating light is irradiated.

As shown at step (a) of FIG. 3, an organic compound is coated on the surface of the photosensitive layer 3 which is entirely hydrophilized in the previous step [the step of deleting image (step S240)], and then a reaction and/or interaction is caused between the organic compound and the surface of the photosensitive layer 3 [the step of hydrophobizing the plate surface (step S200)]. The diagram of step (a) of FIG. 3 illustrates an initial state in which the surface of the photosensitive layer 3, or the entire surface of the printing plate 5 is coated with the organic compound and thereby hydrophobized. In this case, as shown in FIG. 1, the hydrophobized surface of the printing plate 5 is the surface of the printing plate 5 which exhibits a contact angle of water 6 of 50° or more, and more preferably 80° or more. Thus, it is easy for a hydrophobic ink for the printing to attach thereto while it is hard for a dampening water to attach thereto.

Further, the state of the surface of the photosensitive layer 3 referrers to as “initial state of the printing plate fabrication”. This “initial state of the printing plate fabrication” can be regarded as a timing point at which the step of printing (step S220) actually starts. In more concretely, this state can be regarded as one in which digitized data concerning an arbitrary image is already prepared and the data is tried to be written on the printing plate 5.

Thereafter, as shown at step (b) of FIG. 3, as the step of image writing (step S210), an image is written on the surface of the photosensitive layer 3 brought into the hydrophobic state.

This image writing is carried out in such a manner that, on the basis of the digital data concerning the image, the non-image area is written on the surface of the photosensitive layer 3 so as to correspond to the data thereof. In this way, the image writing is carried out. In this case, as shown in FIG. 2, the non-image area is a hydrophilic area on which the contact angle of water 6 is equal to or smaller than 10°. Thus, it is easy for a dampening water to attach thereto while it is hard for a hydrophobic ink for the printing to be accepted thereby.

As a method for creating the hydrophilic non-image area based on the image data, an activating light is irradiated onto the photosensitive layer 3 containing a photocatalyst which has a nature exhibiting a photocatalyst activity in response to light having a wavelength equal to or smaller than 600 nm, i.e., an activating light. With this activating light irradiation, the photocatalyst is activated to oxidize and decompose the organic compound, whereby the organic compound can be removed from the surface of the photosensitive layer 3. At the same time, the surface of the photosensitive layer 3 is hydrophilized.

On the other hand, a area of the surface of the photosensitive layer 3 having no activating light irradiated thereon is left unchanged in its state of exhibiting hydrophobic nature. Thus, the surface of the printing plate 5 comes to have a hydrophilic area and a hydrophobic area formed. That is, as for example shown in FIG. 5, a area 3a having the activating light irradiated thereon is made to be a non-image area exhibiting the hydrophilic nature while a area 3b having no activating light irradiated thereon is made to be an image area exhibiting the hydrophobic nature, whereby the plate can be fabricated.

In the step (b) of FIG. 3, the non-image area 3a is written by a writing head employing a visible light, e.g., a violet laser with a wavelength of 405 nm. Thus, the non-image area 3a is formed on the surface of the hydrophobic photosensitive layer 3.

As for a method for creating the hydrophilic non-image area 3a based on the image data, in addition to the writing head using the violet laser having a wavelength of 405 nm, a unit for writing image using the activating light may be utilized. For example, an arrangement may be effected to construct a writing head by cooperatively introducing a light source capable of generating light having a wavelength of 360 nm to 450 nm employed in UV-Setter 710 which is released from basysPrint Corporation (Germany) and a micro mirror.

When the above-described image writing step (step S210) is completed, as shown at step (c) of FIG. 3, the image area and non-image area are formed on the surface of the photosensitive layer 3, and then the printing is made allowable in the next printing step (step S220).

In the printing step (step S220), the printing plate 5 is coated on the surface thereof with a dampening water and a so-called emulsified ink having a hydrophobic printing ink and the dampening water mixed therein.

Therefore, if an image shown in FIG. 5 is written, for example, the halftone representation portion (i.e., the hydrophobic image area) 3b is attached with the hydrophobic ink. Conversely, the remaining blank portion (i.e., hydrophilic non-image area) 3a is attached with the dampening water with priority and the hydrophobic ink is repelled and prevented from attaching thereto. In this way, the image (pattern) appears and the surface of the photosensitive layer 3 can function as a printing plate. Thereafter, the printing is carried out and the printing is completed.

A method of regenerating the printing plate will be hereinafter described.

In the following description, the term “regeneration of a plate” means a set of processes including a process to hydrophilize entirely and uniformly a printing plate 5 having a surface exhibiting a hydrophobic nature at at least a area thereof and a hydrophilic nature at the remaining area thereof, thereafter to supply an organic compound to the hydrophilic surface of the printing plate 5 on the surface of the photosensitive layer 3 so that a reaction and/or interaction is caused in the organic compound with the photosensitive layer 3, to convert the surface characteristic of the photosensitive layer 3 (i.e., surface characteristic of the photocatalyst) from hydrophilic into hydrophobic, and again to recover the “initial state of the printing plate fabrication”.

The process for entirely and uniformly hydrophilize the surface of the printing plate 5 before the hydrophobization processing is carried out so that the image of the plate can be completely deleted.

Initially, as shown at step (d) of FIG. 3, as the ink removing step (step S230), ink, dampening water, paper dust and so on attached to the surface of the photosensitive layer 3 after completing the printing are removed. The methods for removing the ink include a method for stopping ink supply to the surface of the printing plate 5 and decreasing the amount of ink on the printing face, a method for wiping off the ink on the surface of the printing plate 5 by a mechanism reeling the cloth-like tape for wiping off the ink, a method for wiping off the ink on the surface of the printing plate 5 by a roller having a cloth-like material wound around it for wiping off the ink, a method for spraying a washing liquid by a sprayer onto the surface of the printing plate 5 to wash the ink off, and so on. Any method can be properly selected.

Thereafter, as shown at step (e) of FIG. 3, the activating light is irradiated on the entire surface of the photosensitive layer 3 so that even the image area 3b can be hydrophilized and the entire surface of the photosensitive layer 3 becomes a hydrophilic surface of which contact angle of water 6 equals to or smaller than 10°. That is, the entire surface of the photosensitive layer 3 is made to take the state shown in FIG. 2. Thus, the image can be completely deleted [image deleting step (step S240)].

At this time, one of the features of the present invention is that when the activating light is irradiated on the surface of the photosensitive layer 3, the surface of the photosensitive layer 3 is heated simultaneously. In other words, if the surface of the photosensitive layer 3 is heated under the activating light irradiation, then the decomposing reaction of the organic compound can be accelerated on the surface of the photosensitive layer 3, with the result that the image of the plate can be deleted for a short period of time.

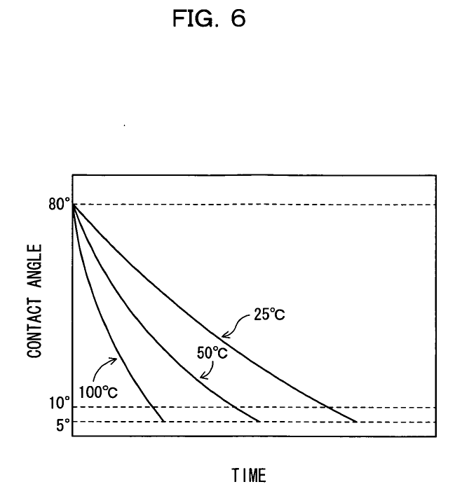

Further, as shown in FIG. 6, the higher the temperature at which the surface of the photosensitive layer 3 is heated under the activating light irradiation, the shorter the time period required for making the contact angle of water 6 equal to or smaller than 10° i.e., the shorter the time it takes for the surface of the photosensitive layer to be hydrophilized becomes. Accordingly, the hydrophilization of the surface of the printing plate 5 can be promoted.

In this example, as shown at step (e) of FIG. 3, the surface of the photosensitive layer 3 is irradiated with the activating light by an ultraviolet (UV) lamp as well as the photosensitive layer 3 is heated by an infrared ray (IR) lamp.

As a method of heat application, it is preferable to employ hot air ventilation or light irradiation capable of heating the surface of the photosensitive layer 3. Further, as light for irradiation, an infrared light ray is preferable if a kind of light is selected from the heating efficiency standpoint. Furthermore, if heat is applied to the plate surface, means therefor may be an electric heater.

Other method of heat application includes a method in which a heater is provided within a plate cylinder to which the printing plate 5 is attached and heat is applied, for example. According to this method, the plate cylinder itself will be heated up to an excessively high temperature. Therefore, in the subsequent printing step (step S220), physical properties influencing the printing quality such as the viscosity of the ink can be fluctuated due to the influence of the temperature. Accordingly, some consideration is requested upon employing this method.

In the image deleting step (step S240), the photosensitive layer 3 recovers the hydrophilicity on the entire surface thereof owing to the heat application under the activating light irradiation. Then, the processing returns to the hydrophobization step (step S200) of the plate surface shown at step (a) of FIG. 3, in which the organic compound is supplied thereto to bring the organic compound into a reaction and/or interaction with the photosensitive layer 3 so that the characteristic of the surface of the photosensitive layer 3 (photocatalyst surface characteristic) is converted from hydrophilic to hydrophobic (i.e., hydrophobization processing is carried out). Thus, initial state of the printing plate fabrication can be taken place.

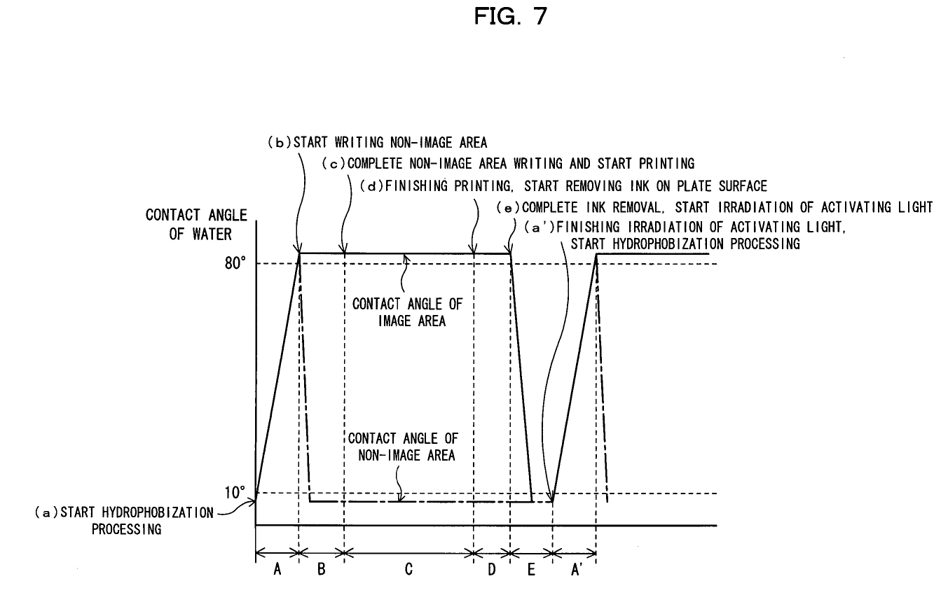

FIG. 7 is a graph illustrating collectively what has been described above. In the graph of FIG. 7, time (or operation) is plotted in abscissa while the contact angle of water 6 on the surface of the printing plate 5 is plotted in ordinate. Therefore, this graph illustrate show the contact angle of water 6 on the surface of the photosensitive layer 3 varies with time elapse or operation in regard to the printing plate 5 of the present invention. That is, reference can be made to examine which of the hydrophobic state or hydrophilic state the surface takes. In FIG. 7, a one-dotted chain line represents the variation of the contact angle of the non-image area 3a while a solid line represents the variation of the contact angle of the image area 3b.

Initially, the activating light is irradiated onto the surface of the photosensitive layer 3 so that the surface of the photosensitive layer 3 is brought into a high hydrophilicity exhibiting state such that the contact angle of water 6 is equal to or smaller than 100°.

Then, as the hydrophobization step of the plate surface (step S200) (step shown at A in FIG. 7), the organic compound is supplied to the surface of the photosensitive layer 3 to bring the organic compound into a reaction and/or interaction with the photosensitive layer 3 so that the characteristic of the photocatalyst of the photosensitive layer 3 is converted from hydrophilic to hydrophobic. Thus, the contact angle of water 6 becomes equal to or greater than 50°, or more preferably the same becomes equal to or greater than 80°. A timing point (a) in FIG. 7 represents a starting timing point of the hydrophobization processing while timing point (b) in FIG. 7 represents an ending timing point of the hydrophobization processing, that is, the initial state of the printing plate fabrication.

Thereafter, as the image writing step (step S210) (non-image area writing step, step shown at B in FIG. 7), the activating light is irradiated onto the hydrophobic surface of the photosensitive layer 3 so that the writing of the non-image area 3a is started [timing point (b) in FIG. 7]. In this way, the surface of the photosensitive layer 3 having the activating light irradiated thereon is converted from hydrophobic to hydrophilic. In other words, the contact angle of water 6 on the surface of the photosensitive layer 3 becomes equal to or smaller than 10°. On the other hand, the surface of the photosensitive layer 3 having no activating light irradiated thereon stays in the hydrophobic state. Thus, the area having no activating light irradiated thereon becomes the hydrophobic image area 3b while the area having the activating light irradiated thereon becomes the hydrophilic non-image area 3a, with the result that the surface can function as a plate.

Then, after the non-image area 3a has been written, as the printing step (step S220) (step shown at C in FIG. 7), the printing is started [timing point (c) in FIG. 7].

After the printing is completed, as the ink removing step (step S230) (step shown at D in FIG. 7), ink left on the surface of the photosensitive layer 3 dust and the like are removed [timing point (d) in FIG. 7].

After the ink removal is completed, as the image deleting step (step S240) (step shown at E in FIG. 7), the activating light is irradiated on the surface of the photosensitive layer 3 and the surface of the photosensitive layer 3 is heated [timing point (e) in FIG. 7]. In this way, the hydrophobic image area 3b can be swiftly decomposed and removed owing to the photocatalyst, and the photocatalyst is converted from hydrophobic to hydrophilic. Thus, the entire surface of the photosensitive layer 3 can be hydrophilic. In other words, owing to the image deleting step (step S240) the history of the plate can be completely deleted.

Thereafter, as the next hydrophobizing step of the plate (step S200) (step shown at A′ in FIG. 7), the organic compound is again supplied to the surface of the photosensitive layer 3 so as to bring the organic compound into reaction and/or interaction with the photosensitive layer 3 [timing point (a′) in FIG. 7], whereby the “initial state of the printing plate fabrication” can be recovered on the printing plate 5. Thus, the printing plate 5 can be reused.

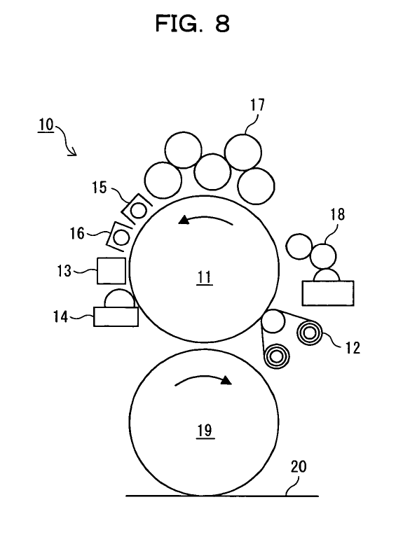

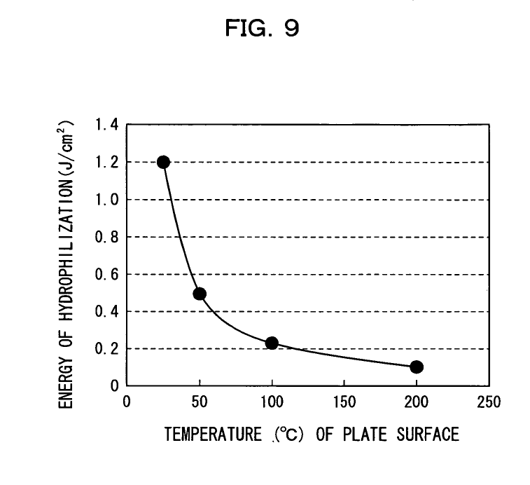

When the above printing and plate regeneration are carried out on a printing press, it is preferable to employ a printing system (printing press) 10 shown in FIG. 8.

The printing press 10 is composed of a plate cylinder provided at the center thereof, a plate cleaning unit 12 provided around the plate cylinder, an imaging unit 13, an organic compound applying unit 14, a heating unit 15, a hydrophilization processing-use activating light irradiating unit 16 serving as an image deleting unit, an inking roller 17, a dampening water applying unit 18 and a blanket cylinder 19. The printing plate 5 is wound around the plate cylinder 11.

The plate regeneration and fabrication will be hereinafter described with reference to FIG. 8. Initially, the plate cleaning unit 12 is brought contact to the plate cylinder 11 so that ink, dampening water, paper dust and so on attached to the surface of the plate cylinder 5 can be cleanly wiped off. Although the plate cleaning unit 12 shown in FIG. 8 is one having a mechanism reeling up a cloth tape for wiping ink, the arrangement of the unit is not limited thereto.

Thereafter, the plate cleaning unit 12 is brought apart from the plate cylinder 11 and the heating unit 15 is activated on the surface of the printing plate 5 to heat the same. At the same time, the hydrophilization processing-use activating light irradiating unit 16 is activated to irradiate the activating light on the entire surface of the printing plate 5. Thus, the entire surface of the printing plate 5 is hydrophilized. In this case, an ultraviolet light having a wavelength of 400 nm or less is employed as the activating light. However, if the photocatalyst exhibits an activating nature under light having a wavelength from 400 nm to 600 nm, the light having the wavelength from 400 nm to 600 nm may be employed.

Then, the organic compound applying unit 14 is activated to supply the organic compound to the entire surface of the printing plate 5 so as to bring the organic compound into the interaction with the photosensitive layer 3, whereby the printing plate 5 can be entirely hydrophobized. Although in FIG. 8 the organic compound applying unit 14 is a roller coating unit, the arrangement of the unit is not limited thereto.

Subsequently, the image writing unit 13 is activated to irradiate the activating light onto the surface of the printing plate 5 on the basis of the digital data of the image prepared in advance, thus the non-image area 3a is written (i.e., the image is written on the surface of the printing plate 5).

After the image is written, the inking roller 17, the fountain solution feeder 18, and the blanket cylinder 19 are brought contact to the plate cylinder so that a sheet of paper 20 is kept contact to the blanket cylinder 19. Then, the cylinders are rotated in the directions indicated in the arrows in FIG. 8, respectively, whereby the printing plate 5 is supplied on the surface thereof with the dampening water and the ink in order and printing is carried out on the sheet of paper 20.

As described above, in the printing press 10, the plate cleaning unit for cleaning the surface of the printing plate 5 attached to the plate cylinder 11, the hydrophilization processing-use activating light irradiating unit 16 for carrying out image deletion with the activating light irradiation, the organic compound applying unit 14 for applying the organic compound onto the surface of the printing plate 5, and the heating unit 15 for heating the surface of the printing plate 5 to promote the hydrophilization, collectively function as a regenerating apparatus for regenerating the plate. Furthermore, the printing press is arranged to include the imaging unit 13 for writing an image on the printing plate 5. Therefore, a series of processes of the plate regeneration and plate making can be carried out under the condition that the printing plate 5 is attached to the plate cylinder 11 of the printing press 10. With this arrangement, the series of printing work can be executed without halting the printing press 10 and interposing the exchanging work of the printing printing plate.

While the printing press 10 has an arrangement in which the printing plate 5 is wound around the plate cylinder 11, the present invention is not limited thereto. That is, it is needless to say that other arrangement can be employed in such a manner that the photosensitive layer 3 containing the photocatalyst is directly provided on the surface of the plate cylinder 11, i.e., the plate cylinder 11 and the printing plate 5 may be unitarily constructed.

Subsequently, description will be made on the printing plate, a method of fabricating the printing plate, and a method of regenerating the printing plate. In particular, description will be focused on the sequence of the plate-making and plate regeneration and the advantages thereof together with more concrete examples that was confirmed by the inventors of the present invention.

Catalyst Preparation

Titanium sulfate as a raw material (Wako Pure Chemical Industries, Ltd.) was prepared and this agent was added with ammonium water by stirring the mixture. Thus, a hydrolysis of the titanium sulfate was obtained. This hydrolysis was filtered by using a suction funnel and washed by ion-exchange water until the filtered liquid came to have an electric conductivity equal to or smaller than 2 μS/cm. After the washing, the hydrolysis was dried at a room temperature and then burned for two hours at 400° C. in the atmosphere. The burned material was reduced to coarse grain in a mortar to obtain a photocatalyst powder.

Confirmation of Activity by Visible Light

The above-described photocatalyst powder was picked up by 0.2 g and uniformly spread on a bottom of a cylindrical reaction vessel (volume 500 ml) made of Pyrex (R) glass. Then, the reaction vessel was evacuated and the inner air was substituted with highly purified air. Thereafter, acetone was poured into the vessel so that the concentration thereof within the reaction vessel became 500 ppm. Then, the powder was left at a temperature of 25° C. in a dark place for ten hours until the adsorption of the powder reached an adsorption equilibrium. Thereafter, light (main wavelength of 470 nm) was irradiated onto the powder by using a blue LED produced by NICHIA chemical industry. Then, the amount of acetone and CO₂ were measured by a gas chromatograph produced by Shimadzu Corp. This measurement reveals that there was no acetone found after irradiation by the blue LED for 25 hours, and instead of this disappear of acetone, generation of CO₂ of which stoichiometric ratio corresponded to that of acetone was confirmed. That is, it is successfully confirmed that the aforesaid photocatalyst powder exhibits the photocatalyst activity with the light having the wavelength of 470 nm.

Fabrication of Printing Plate

The above-described photocatalyst powder was dispersed within an ion-exchange water to produce a slurry having a 20 weight percent of solid body component. This slurry was reduced to powder by a wet mill (trade name: DAINO mill PILOT) to obtain the photocatalyst dispersed liquid.

A substrate made of a stainless steel plate (SUS 301) having an area of 280×204 mm and thickness of 0.1 mm was prepared and this plate was subjected to an alkali degrease processing, thus the substrate 1 was obtained.

The above-described photocatalyst dispersed liquid was mixed with a titanium oxide coating agent TKC-301 produced by TAYCA Corporation at a weight percent ratio of 1:8, and the resulting liquid was coated on the aforesaid substrate 1 by dip coating. This substrate was heated up to a temperature of 350° C. so as to create the photosensitive layer 3 containing the photocatalyst on the surface of the base plate. The thickness of the photosensitive layer 3 was about 0.1 μm. The water contact angle of the printing plate surface was measured by using a CA-W type contact angle meter manufactured by Kyowa Kaimen Kagaku Co., Ltd., and a contact angle of 80 was obtained. This measurement proved that satisfactory hydrophilicity was achieved.

Preparation of Hydrophobization Processing Liquid

Two gram of an organic compound, isopropoxy titanium octylene glycol (produced by Nippon Soda Co., Ltd.) was dissolved in 98 g of a paraffin type solvent (trade name: Isoper L, a product of Exxon Mobile Co.) to obtain hydrophobization processing liquid X.

The printing plate exhibiting the hydrophilization was set on a desktop offset printing press “NEW ACE PRO” manufactured by Alpha Techno Company, the aforesaid hydrophobization processing liquid X was coated on the plate surface by using a sprayer and the plate was dried by a hot air drier. This printing plate was once removed from the printing press and the water contact angle of the surface was measured by the aforesaid contact angle meter. The measurement revealed that the contact angle thereof was 75°. This measurement proved that satisfactory hydrophobicity was achieved and it was confirmed that the aforesaid printing printing plate was brought into the initial state upon plate-making.

Image Writing

Subsequently, an imaging unit using a semiconductor laser having a wavelength of 405 nm, an output power of 5 mW/channel and a beam diameter of 15 μm was activated for the plate surface to write halftone images with a printing element rate varying from 10% to 100% at a step of 10%. The water contact angle of the printing plate surface after completing the writing step was measured by the aforesaid contact angle meter. It was confirmed that the water contact angle at a portion on which an image was written by the semiconductor laser was 8° and this portion became a hydrophilic non-image area while the contact angle at a portion on which no image was written was 75° and this portion became an image area keeping the hydrophobic nature.

Printing

This printing plate was set on the aforesaid desktop offset printing press “NEW ACE PRO”, printing was performed on AIBESTO paper with an ink HYECOOB Red MZ manufactured by Toyo Ink Manufacturing Co., Ltd. and dampening water, a 1% solution of LITHOFELLOW manufactured by Mitsubishi Heavy Industries, Ltd. at a printing speed of 3500 sheets/hour. The halftone image was successfully printed on from a first sheet of paper fed at the start of printing.

Regeneration of Printing Plate

After the printing was completed, the ink, the dampening water, the paper dust and the like attached to the plate surface were cleanly wiped off. Then, an infrared light was irradiated on the entire surface of the plate by using a halogen lamp so as to heat the plate surface. At the same time, a low-pressure mercury lamp was utilized to irradiate an ultraviolet light having a wavelength of 254 nm and a luminous flux density of 10 mW/cm². Thus, the image area of the surface of the printing plate 5 was decomposed, and the surface of the printing plate 5 was hydrophilized to delete the image. The halogen lamp could be placed under adjustment in the supplied voltage with a slidax so as to adjust the temperature of the plate surface. The temperature of the plate surface was measured by a thermistor so as to determine the amount of irradiation energy of the aforesaid ultraviolet ray which was required for bringing the image area exhibiting the contact angle of 75° into the hydrophilic surface exhibiting the contact angle of 100 or less.

FIG. 9 shows the relationship between the hydrophilization energy (irradiation energy of the ultraviolet light) required for hydrophilizing the plate surface and the temperature of the plate surface. If the temperature of the plate surface was set to 25° C. (the halogen lamp was not turned off), irradiation energy of the ultraviolet light of 1.2 J/cm² was required for the hydrophilization. However, when the halogen lamp was turned on to heat the plate surface, as the increase of the temperature of the plate surface, the required irradiation energy was decreased. When the temperature thereof reached 50° C., the irradiation energy was decreased down to half the amount of energy thereof. When the temperature thereof reached 200° C., the irradiation energy was decreased down to 0.1 J/cm². This energy corresponds to an amount of energy provided by ten seconds irradiation of a lamp having a luminous flux density of 10 mW/cm². This fact teaches us that the aforesaid image deleting requires 120 sec. under no heat application condition while the same requires only ten seconds under the condition that the plate surface is heated up to 200° C. That is, it was confirmed that the plate regeneration can be swiftly carried out owing to the heat application to the plate surface. It was confirmed that, with the hydrophilization processing, the printing plate recovered the state before the organic compound was supplied, and the plate regeneration was accomplished.

As described above, if the plate surface temperature is increased up to 50° C. or more, the irradiation energy can be obviously decreased. Conversely, if the plate surface temperature is excessively increased (about 200° C. or more), the plate surface will be negatively influenced in its physical properties. Accordingly, it is preferable for the plate surface (surface of the photosensitive layer 3) to be heated to a temperature in a range from 50° C. to 200° C.

### [2] SECOND EMBODIMENT

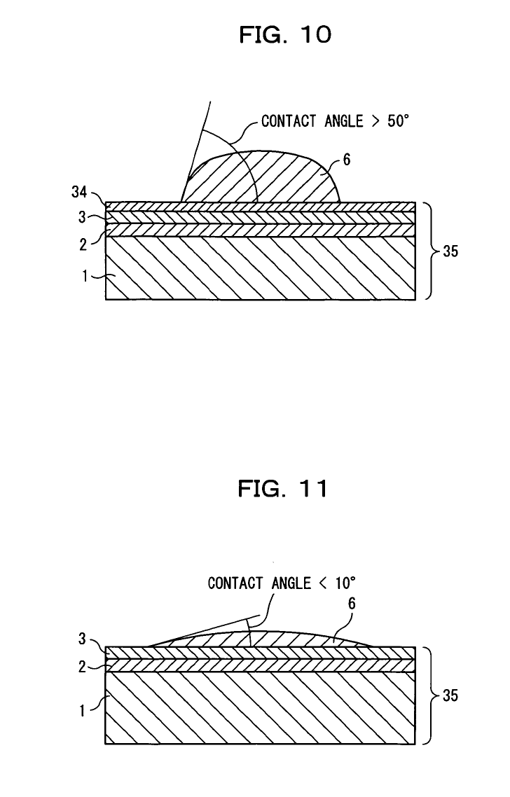

FIGS. 10 and 11 are diagrams each showing the printing plate (layered formation) according to a second embodiment of the present invention. FIG. 10 is a cross-sectional view showing a case in which the printing plate surface exhibits the hydrophobic nature while the FIG. 11 is a cross-sectional view showing a case in which the printing plate surface exhibits the hydrophilic nature.

As shown in FIG. 10, a printing plate 35 is fundamentally composed of the substrate 1, the intermediate layer 2, the photosensitive layer 3 and a thermoplastic resin-melt layer 34 formed by heating and melting resin fine particles. The printing plate 35 is sometimes simply referred to as a printing plate. Also, if the printing plate comes to have an image area for the printing formed on the surface thereof, this printing plate may be referred to as a plate.

The substrate 1, the intermediate layer 2 and the photosensitive layer 3 are similar to those described in the description of the first embodiment, and hence they will not be described. Therefore, description will be hereinafter made in detail on a matter different from that of the first embodiment.

According to the present embodiment, an organic compound (type B) employed in the embodiment is different from the organic compound (type A) which was utilized for coating the surface of the photosensitive layer 3 of the first embodiment.

The thermoplastic resin-melt layer 34 is formed in such a way that the aforesaid type B organic compound is coated on the surface of the photosensitive layer 3 and subjected to a heat treatment.

The organic compound (type B) is a thermoplastic resin. A method of coating the organic compound is such that fine particles of this resin are dispersed in a liquid such as water or an organic solvent and this dispersed liquid is coated on the plate surface. After coating the liquid containing the thermoplastic resin particles on the plate surface, the liquid is dried by means of air ventilation or the like depending on necessity. Thereafter, when heat is applied to a region which is desired to be formed into the hydrophobic image area, the resin fine particles are melted by the heat and formed into a film-like sheet. Thus, the film-like sheet is brought into reaction and/or interaction with the photosensitive layer 3 on the surface thereof to be fixed thereon, with the result that the film-like sheet serves as the hydrophobic image area.

As a method of heat application, similarly to the aforesaid case, any method may be properly selected from inactivating light irradiation, thermal head and so on. However, it is preferable to select away of heat treatment by the inactivating light irradiation. In more preferably, image writing with an infrared light is desirable. If such a kind of light light is selected for irradiation, the organic compound will melt without decomposition. Moreover, the organic compound will be formed into the film-like sheet and brought into reaction and/or interaction with the photosensitive layer 3 to adhere on the layer.

In the following description, terms “fine particles of the thermoplastic resin” means “thermoplastic resin fine particles which have both of a nature that the particles are formed into a film-like sheet owing to a heat treatment, melted and brought into reaction and/or interaction with the surface of the photosensitive layer 3 or fixed on the surface of the photosensitive layer 3, thereby to hydrophobize the surface of the photosensitive layer 3, and a nature that the particles are decomposed in response to the activating light with the action of the photocatalyst”. Further, in the present invention, the thermoplastic resin fine particles may be sometimes denoted by “imaging member”.

In this case, the term reaction and/or fixing means that the film-like sheet is applied with heat and melted so that the sheet is intimately contacted with the surface of the photosensitive layer 3 with a certain strength that is large enough to maintain the intimate contact with the surface even when the surface of the printing plate 35 undergoes the printing process. Further, the meaning of the term reaction and/or fixing includes all cases of intimate contact between the film-like sheet and the photosensitive layer regardless of whether or not any chemical reaction is brought about between them and whether the binding is a physical binding or chemical binding.

The diameter of the fine particles of the thermoplastic resin may be preferably 5 μm or less as a primary particle and more preferably 1 μm or less. If the diameter of the particle is excessively large, a film formed by the heat application and melting, i.e., the image area comes to have an excessive thickness, with the result that it will take too much time to decompose the image area in the regeneration step, which fact makes the regeneration step unpractical.

Furthermore, the thermoplastic resin fine particles desirably have a nature which substantially prohibits the aforesaid reaction or fixing under a room temperature, in addition to a nature that the particles are formed into a film-like sheet owing to a heat treatment, melted and brought into a chemical reaction with the hydrophilic area of the surface of the printing plate 35 or strongly fixed on the surface of the same, thereby to hydrophobize the surface of the photosensitive layer 3.

Various kinds of resins are known as such a thermoplastic resin. However, as the printing plate-use hydrophobizing agent of the present invention, it is desirable to select a resin which makes it possible to form particles having the aforesaid fine particle diameter. Preferable resins include an acrylic resin such as acrylic (methacrylic) acid and acrylic (methacrylic) ester, styrene type resin, styrene acrylic type resin such as styrene acrylic acid and styrene acrylic ester, urethane type resin, phenolic resin, ethylene type resin such as ethylene, ethylene acrylic acid, ethylene acrylic ester, vinyl ethylene acetate, denatured vinyl ethylene acetate, vinyl type resin such as vinyl acetate, vinyl propionate, polyvinyl alcohol, polyvinyl ether.

It is needless to say that one of these resins may be solely utilized or plural of them may be mixed with one another depending on necessity and the resultant mixture may be utilized. It is noted that these resins have an advantage that they will not create a harmful component such as chloric compound upon decomposition. Furthermore, it is needless to say that the liquid containing the thermoplastic resin particles includes so-called emulsion or latex.

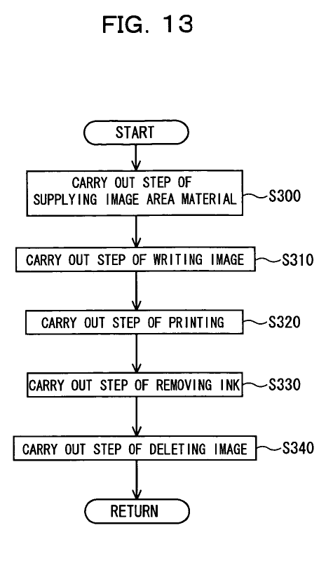

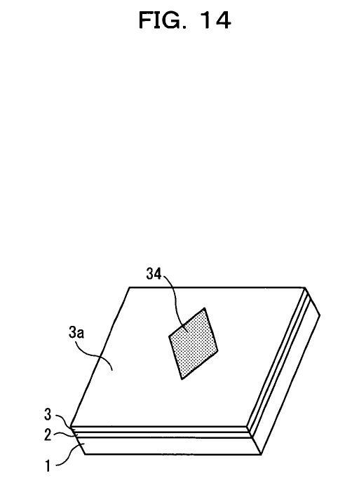

Subsequently, description will be made on a method of fabricating the planographic printing plate and a method of regenerating the same. As shown in FIG. 13, a flow of fabricating the plate and regeneration therefor of the present embodiment is composed of an image area material applying step (organic compound applying step) (S300), an image writing step (S310), a printing step (S320), an ink removing step (S330), an image deleting step (S340).

Initially, the method of fabricating the printing plate will be described.

In the following description, a term “fabrication of plate” means a series of steps that a liquid containing resin fine particles (organic compound) is coated on the surface of the photosensitive layer 3, and then at least a part of the surface of the printing plate 35 is subjected to a heat treatment based on digital data to form a hydrophobic image area, resin fine particles on the surface of the printing plate having undergone no heat treatment are removed to expose the hydrophilic photosensitive layer 3, and there is formed a latent image consisting of the hydrophobic image area and the hydrophilic non-image area on the surface of the printing plate 35.

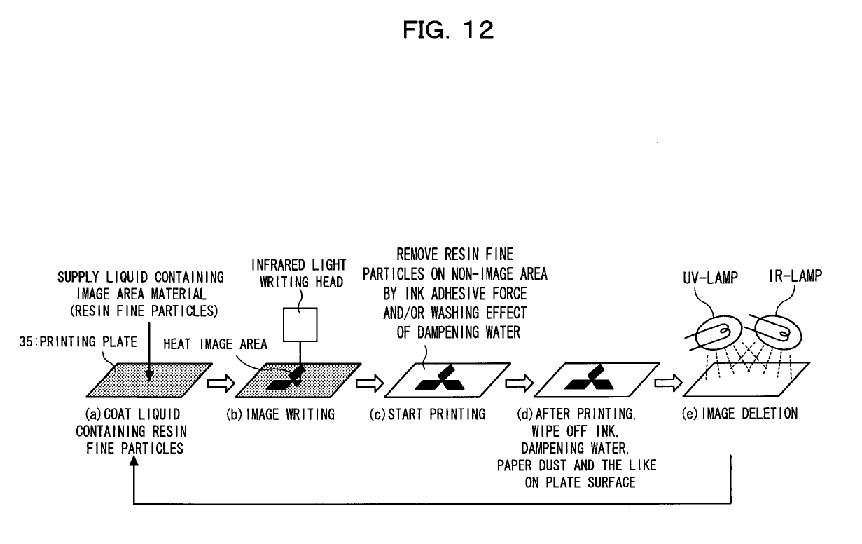

Initially, as shown at step (a) in FIG. 12, the liquid containing the organic compound (resin fine particles), which is expected to constitute the image area material, is coated on the surface of the photosensitive layer 3 which has been wholly hydrophilized in the previous step [image deleting step (step S340)]. the coated surface may be dried in an atmosphere at about a room temperature, if necessary.

Further, the state of the surface of the photosensitive layer 3 referrers to as “initial state of the printing plate fabrication”. This “initial state of the printing plate fabrication” can be regarded as a timing point at which the step of printing actually starts. In more concretely, this state can be regarded as one in which digitized data concerning an arbitrary image is already prepared and the data is tried to be written on the printing plate 35.

Thereafter, as shown at step (b) of FIG. 12, as the step of image writing (step S310), an image is written on the surface of the photosensitive layer 3.

This image writing is carried out in such a manner that, on the basis of the digital data concerning the image, the image area is written on the surface of the photosensitive layer 3 so as to correspond to the data thereof. In this way, the image writing is carried out. In this case, as shown in FIG. 10, the image area is a hydrophobic area on which the contact angle of water 6 is equal to or larger than 50°, or more preferably, the same is equal to or larger than 80°. Thus, it is easy for a hydrophobic ink for the printing to attach thereto while it is hard for the dampening water to be accepted thereby.

As described above, as a method of creating the hydrophobic image area based on the image data, a suitable one is that the resin fine particle layer is heated to melt the resin fine particles so that the resin fine particles are formed into the film-like sheet on the surface of the photosensitive layer 3, and at the same time, the film-like sheet is brought into the reaction with the surface of the photosensitive layer 3 or fixed on the same. After the image area is heated, the resin fine particles on a portion which was not applied with heat are removed. Thus, the non-image area can be created on the surface and as a consequence, the plate can be fabricated.

As a method for the above heat application, similarly to the aforesaid case, an inactivating light, e.g., an infrared light may be preferably selected for irradiation and the heat treatment.

In this case, as shown at step (b) in FIG. 12, the infrared light is irradiated by using an infrared ray writing head so that at least a part of the resin fine particle mass is heated and melted to form a film-like sheet and brought to the reaction with the surface of the photosensitive layer 3 or fixed on the same. Thus, the image area can be formed.

After the image area is formed, as shown at step (c) in FIG. 12, the resin fine particles on a portion of the surface of the plate surface 35 on which no image writing has been executed in the stage soon after the start of printing, are removed from the surface by the ink adhesiveness and/or the washing action of the dampening water. Thus, the non-image area appears. In this way, as shown at step (c) in FIG. 12, the image area and the non-image area can be completely formed on the surface of the photosensitive layer 3, and the printing operation can be executed.

While in the example description has been made on an arrangement in which the image area is written by the infrared light, it is needless to say that other arrangement may be employed such as of direct heat application onto the resin fine particle coating surface with a thermal head, for example.

When the above-described processing has been completed, in the printing step (step S320) shown at step (c) in FIG. 12, the printing plate 35 is coated on the surface thereof with the dampening water and a so-called emulsified ink as a mixture of the hydrophobic ink and the dampening water. Thus, the printing plate shown in FIG. 14 has been fabricated, for example.

FIG. 14 shows a state of the printing plate having a halftone dot notation portion. This halftone dot notation portion indicates the thermoplastic resin-melt layer 34, or the hydrophobic image area, which derives from a series of processes in which heat is applied to the resin fine particles to melt them so as to form them into the film-like sheet, the layer is brought into reaction with the surface of the photosensitive layer 3 containing the photocatalyst or fixed thereon, and the hydrophobic ink is attached thereon. The remaining blank portion (surface of the photosensitive layer 3), i.e., the hydrophilic non-image area 3a is brought into a state in which the dampening water is attached thereto with priority and the hydrophobic ink is repelled and prevented from attaching thereto. In this way, the image (picture pattern) is created and the surface of the photosensitive layer 3 comes to have a function of the printing plate 35. Thereafter, the printing is executed and the printing is completed.

A method of regenerating the printing plate will be hereinafter described.

In the following description, the term “regeneration of a plate” means a set of processes including a process to hydrophilize entirely and uniformly a printing plate which at least partially has a surface exhibiting a hydrophobic nature and a hydrophilic nature at the remaining area thereof, thereafter to coat the liquid containing the resin fine particles as the organic compound on the hydrophilic surface of the printing plate, and to dry the surface of the printing plate in an atmosphere at about a room temperature depending on necessity, thereby to recovering the “initial state of the printing plate fabrication”.

In the process of “plate regeneration”, initially, as the ink removing step (step S330) shown at step (d) in FIG. 12, the ink, the dampening water, paper dust and the like attached to the surface of the photosensitive layer 3 after undergoing the printing process are removed.

Thereafter, in the image deleting step (step S340) shown at step (e) in FIG. 12, an activating light having an energy level higher than the band gap energy of the photocatalyst is irradiated onto the entire surface of the photosensitive layer 3 at least a part of which exhibits a hydrophobic nature, and at the same time, the entire surface of the photosensitive layer 3 is heated. Since the activating light is irradiated on to the entire surface of the photosensitive layer 3, the resin fine particles are melted and the image area 34 composed of the resin fine particles is decomposed and removed. In this way, it becomes possible to hydrophilize the entire surface of the photosensitive layer 3 so that the surface comes to have a contact angle of water 6 of 10° or less, i.e., the surface is brought into the state shown in FIG. 11.

In the illustrated example, ultraviolet light emitted from a UV lamp, as shown in FIG. 12(e), decomposes the image area to expose the hydrophilic portion of photosensitive layer 3.

At this time, one of the features of the present invention is that when the activating light is irradiated on the surface of the photosensitive layer 3, the surface of the photosensitive layer 3 is heated simultaneously. In other words, if the surface of the photosensitive layer 3 is heated under the activating light irradiation, then the reaction for decomposing the organic compound can be accelerated on the surface of the photosensitive layer 3, with the result that the image of the plate can be deleted for a short period of time.

In this example, as shown at step (e) of FIG. 12, the activating light is irradiated onto the surface of the photosensitive layer 3 by using an ultraviolet (UV) lamp and at the same time, an inactivating light is irradiated on the surface of the photosensitive layer 3 to heat the same. The light for heat application is preferably an infrared light from the heating efficiency seeking standpoint, as shown at step (e) of FIG. 12.

Other method for the heat application may be means for ventilating hot air capable of heating the surface of the photosensitive layer 3.

After the image deleting step (step S340) is carried out, the liquid containing the resin fine particles is again coated on the surface of the photosensitive layer 3 which has wholly recovered hydrophilicity, and the surface of the photosensitive layer is dried in an atmosphere at about a room temperature depending on necessity. Thus, the initial state of the plate fabrication can be recovered.

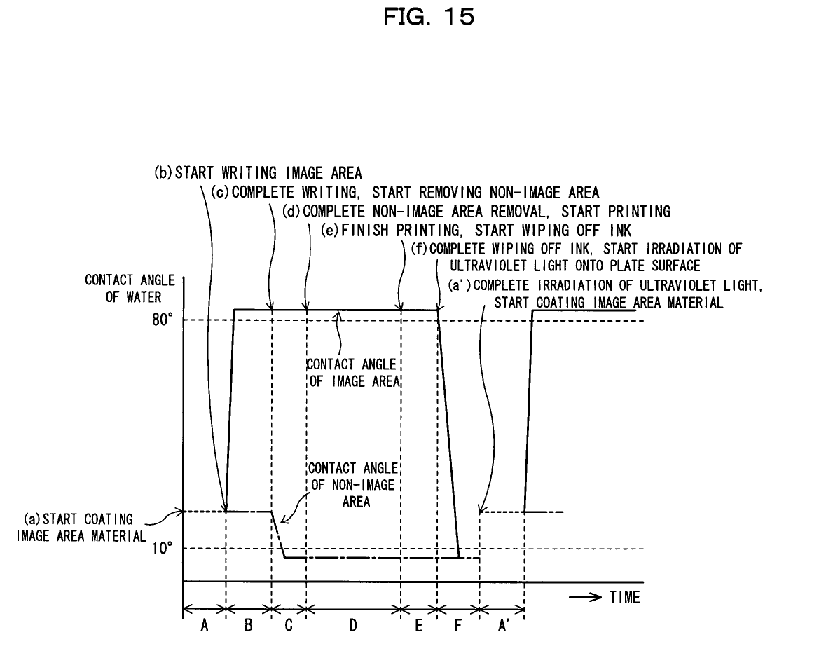

FIG. 15 is a graph illustrating collectively what has been described above. In the graph of FIG. 15, time (or operation) is plotted in abscissa while the contact angle of water 6 on the surface of the printing plate 35 is plotted in ordinate. Therefore, this graph illustrates how the contact angle of water 6 on the surface of the photosensitive layer 3 varies with time elapse or operation in regard to the printing plate 35 of the present invention. In FIG. 15, a one-dotted chain line represents the variation of the contact angle of the non-image area, a broken line (bold broken line starting at starting points a and a′) the variation of contact angle on the surface of the photosensitive layer 3 common to the image area and the non-image area, and a solid line the variation of the contact angle of the image area.

Initially, the ultraviolet light is irradiated onto the surface of the photosensitive layer 3 in advance so that the surface of the photosensitive layer 3 is brought into a high hydrophilicity exhibiting state such that the contact angle of water 6 is equal to or smaller than 10°.

Initially, as the image area material applying step (step S300) (step shown at A in FIG. 15), the photosensitive layer 3 is coated on the surface thereof with the liquid containing the resin fine particles (organic compound) [timing point shown at (a) in FIG. 15]. Thereafter, the photosensitive layer is dried in an atmosphere at about room temperature if necessary. FIG. 12 shows a case in which this drying step is unnecessary. If the photosensitive layer is completely coated with the liquid containing the resin fine particles, it follows that this printing plate is brought into the “initial state of the plate fabrication” [timing point shown at (b) in FIG. 15].

Subsequently, as the image writing step (step S310) (image area writing step, i.e., step shown at B in FIG. 15), heat treatment is effected on a area corresponding to the image area of the resin fine particle coating surface on the surface of the photosensitive layer 3 so that the image area writing is started [timing point shown at (b) in FIG. 15]. With this treatment, the resin fine particles are heated and melted to be formed into a film-like sheet, react with the photosensitive layer 3 or are fixed to the same, and the image area comes to exhibit a high hydrophobic nature. On the other hand, the non-image area of the plate surface can be substantially prohibited from reaction and/or adherence with the resin fine particles, and hence this area maintains the state equivalent to that before the image writing is carried out.

When the image writing is completed, as the non-image area removing step (step shown at C in FIG. 15), at a stage soon after the printing is completed, removal operation for removing the resin fine particles on the non-image area from the surface of the photosensitive layer 3 is started owing to the adhesive force of the ink and/or the washing effect of the dampening water [timing point shown at (c) in FIG. 15]. That is, a area of the hydrophilic surface of the photosensitive layer 3 is exposed as the non-image area. Thus, the surface of the photosensitive layer 3 comes to have the hydrophobic image area which is formed by melting the resin fine particles to provide a film-like resin and reacting or fixing with the surface and the hydrophilic non-image area from which the resin fine particles are removed. Thus, the printing plate can function as a plate.

After the resin fine particles are completely removed from the non-image area, as the printing step (step S320) (step shown at D in FIG. 15), the printing is started [timing point shown at (d) in FIG. 15].

When the printing is completed, as the ink removing step (step S330) (step shown at E in FIG. 15), the ink dust and the like are removed and cleaning is started [timing point shown at (e) in FIG. 15].

After the cleaning is completed, i.e., the ink cleaning is completed, as the image deleting step (step S340) (step shown at F in FIG. 15), the activating light is irradiated onto the surface of the photosensitive layer 3 and at the same time, the surface of the photosensitive layer 3 is heated. In this way, the image area formed by melting the resin fine particles can be swiftly decomposed and removed and the photocatalyst can be converted from hydrophobic to hydrophilic. Thus the entire surface of the photosensitive layer 3 again recovers the hydrophilic nature. Owing to the image deleting step (step S340), the image on the plate can be completely removed.

Thereafter, as the subsequent image area material applying step (step S300) (step shown at A in FIG. 15), the liquid containing the resin fine particles is coated [timing point shown at (a′) in FIG. 15] and the “initial state of the plate fabrication” can be recovered. Thus, the printing plate can be reused.

When the above-described printing and plate regeneration are carried out on the printing press, it is preferable to use the printing press 10 shown in FIG. 8, which has been described in the description for the first embodiment. However, the second embodiment employs the liquid containing the thermoplastic resin fine particles (organic compound type B) which is different from the organic compound of the first embodiment. Therefore, the organic compound applying unit (hydrophobizing unit for the plate surface) 14 shown in FIG. 8 shall be differently arranged from the organic compound applying unit for applying the organic compound (type A) of the first embodiment. That is, it is needless to say that the unit will be arranged to supply the thermoplastic resin particles, i.e., the liquid containing the organic compound (type B). Furthermore, the imaging unit 13 is arranged to irradiate an infrared light onto the surface of the printing plate 35.

Subsequently, the printing plate, the method of fabricating the printing plate, and the method of regenerating the printing plate according to a second embodiment of the present invention will be described. Particularly, the description thereof will be focused on the sequence and advantages of the printing plate fabrication and the plate regeneration by citing concrete examples which were confirmed by the inventors.

Printing Plate Fabrication

Initially, a substrate made of a stainless steal plate (SUS 304) having an area of 280×204 mm and thickness of 0.1 mm was prepared. Then, this substrate 1 is subjected to an anodic oxidation treatment and blackening. Owing to the treatments, improvement was confirmed in the absorptance ratio of the infrared light of 830 nm from 30% before effecting the treatments to 90% after the blackening treatment. This SUS substrate 1 having undergone the blackening was subjected to an alkali degrease treatment and utilized as the substrate 1.

Then, a silica sol having a solid component of 5 wt % contained therein was dip-coated on the substrate 1 and thereafter the base plate underwent a heat treatment for 30 min. at 500° C. Thus, the intermediate layer 2 having a thickness of 0.07 μm was formed.

A photocatalyst-use sol TKS-203 was mixed with the titanium oxide coating agent TKC-301 produced by TAYCA Corporation at a weight percent ratio of 1:4, and the resulting liquid was coated on the surface of the aforesaid intermediate layer 2 by dip coating. The resulting plate was subjected to a heat treatment at a temperature of 500° C. so that the photosensitive layer 3 containing an anatase type titanium dioxide photocatalyst was formed on the printing plate surface. The thickness of the photosensitive layer 3 was set to about 0.1 μm.

Then, the plate was subjected on the entire surface thereof to an ultraviolet light irradiation having a wavelength of 254 nm and a luminous flux density of 10 mW/cm² by using a low-pressure mercury lamp for ten seconds. Thereafter, measurement was immediately made on the ultraviolet light irradiated portion on the water contact angle by using CA-W type contact angle. The measurement revealed that the portion had a contact angle of 70 This measurement proved that satisfactory hydrophilicity was achieved as the non-image area.

Preparation of Hydrophobization Processing Liquid

Subsequently, a styrene acrylic type resin (trade name: J-678) produced by Johnson Polymer was employed as the organic compound, and this compound was dissolved in ethanol to prepare a resin solvent having a concentration of 1 wt %. A surfactant, Ionet T-60-C (produced by Sanyo Kasei) was added to the resin solution at a rate of 10 wt % relative to the resin. Thereafter, an ion exchange water (cool water) was added to the resin solution at a rate of 30 weight units relative to 70 weight units of the resin solution. Thus, the resin fine particles were separated. Thereafter, an evaporator was utilized for evacuating ethanol at a liquid temperature of 40° C., and a water dispersed liquid of the thermoplastic resin fine areaicles was prepared. This water dispersed liquid was utilized as the hydrophobization processing liquid Y. Observation with a scanning electron microscope made on the resin particle revealed that the particles had a spherical shape and the diameter thereof ranged from 0.07 to 0.1 μm.

Image Writing

The aforesaid hydrophobization agent was coated on the entire surface of the printing plate which was made to have the hydrophilic nature owing to the ultraviolet light irradiation. Thereafter, the printing plate was dried in an ventilated atmosphere at a temperature of 25° C. for five minutes, and subsequently, an imaging unit 13 using an infrared ray laser having a wavelength of 830 nm, an output power of 100 mW and a beam diameter of 15 μm was activated for the plate surface to write halftone images with a printing element rate varying from 10% to 100% at a step of 10%. Thus, the resin particles were heated and melted at the irradiated portion, and the resin was fixed on the plate surface to form a thermoplastic resin melted layer 34. The water contact angle at the portion on which the resin fine particles were fixed was measured by the aforesaid CA-W type contact angle meter. The measurement thereof revealed that the water contact angle at the portion was 82° and it was confirmed that an image area was formed.

Printing

This printing plate was set on the aforesaid desktop offset printing press “NEW ACE PRO” manufactured by Alpha Techno Company, printing was performed on AIBESTO paper with an ink HYECOOB Red MZ manufactured by Toyo Ink Manufacturing Co., Ltd. and dampening water, a 1% solution of LITHOFELLOW manufactured by Mitsubishi Heavy Industries, Ltd. at a printing speed of 3500 sheets/hour. It was confirmed that the halftone image was successfully printed on a sheet of paper.

Regeneration of Printing Plate

After the printing was completed, the ink, the dampening water, the paper dust and the like attached to the plate surface were cleanly wiped off. Then, an infrared light was irradiated on the entire surface of the plate by using a halogen lamp so as to heat the plate surface. At the same time, a low-pressure mercury lamp was utilized to irradiate an ultraviolet light having a wavelength of 254 nm and a luminous flux density of 10 mW/cm². Thus, the image area of the surface of the printing plate 5 was decomposed, and the surface of the printing plate 5 was hydrophilized to delete the image. The halogen lamp could be placed under adjustment in the supplied voltage with a slidax so as to adjust the temperature of the plate surface. The temperature of the plate surface was measured by a thermistor so as to determine the amount of irradiation energy of the aforesaid ultraviolet light which was required for bringing the image area exhibiting the contact angle of 82° into the hydrophilic surface exhibiting the contact angle of 10° or less.

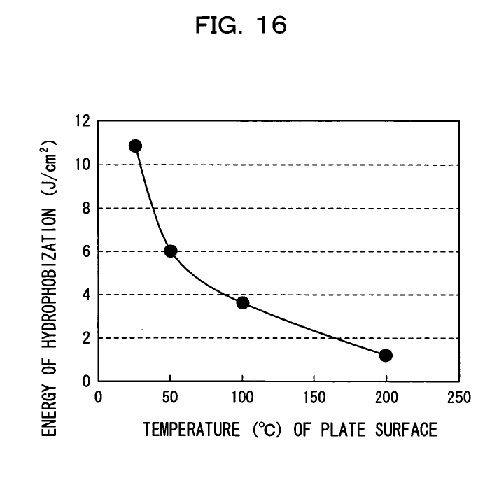

FIG. 16 shows the relationship between the hydrophilization energy (irradiation energy of the ultraviolet light) required for hydrophilizing the plate surface and the temperature of the plate surface. If the temperature of the plate surface was set to 25° C. (the halogen lamp was not turned off), irradiation energy of the ultraviolet light of 10.8 J/cm² was required for the hydrophilization. However, when the halogen lamp was turned on to heat the plate surface, as the increase of the temperature of the plate surface, the required irradiation energy was decreased. When the temperature thereof reached 50° C., the irradiation energy was decreased down to half the amount of energy thereof. When the temperature thereof reached 200° C., the irradiation energy was decreased down to 1.2 J/cm². This energy corresponds to an amount of energy provided by 60 sec. irradiation of a lamp having a luminous flux density of 20 mW/cm². This fact teaches us that the aforesaid image deleting requires 540 sec. under no heat application condition while the same requires only 60 sec. under a heat application condition that the plate surface is heated up to 200° C. That is, it was confirmed that the plate regeneration can be swiftly carried out owing to the heat application to the plate surface. It was confirmed that, with the hydrophilization processing, the printing plate recovered the state before the organic compound was supplied, and the plate regeneration was accomplished.

Accordingly, if the plate surface temperature is increased up to 50° C. or more, the irradiation energy can be obviously decreased. Conversely, if the plate surface temperature is excessively increased (about 200° C. or more), the plate surface will be negatively influenced in its physical properties. Accordingly, it is preferable for the plate surface (surface of the photosensitive layer 3) to be heated to a temperature in a range from 50° C. to 200° C.

As described in detail above, according to the method of regenerating the printing plate, the regenerating apparatus and the printing press of the first embodiment and the second embodiment of the present invention, in addition to the advantage that the printing plate can be reused, there can be obtained a further advantage that the cycle thereof can be more swiftly carried out. That is, after the printing is completed, the time period required for deleting the image area to delete the image of the printing plate can be shortened, with the result that it takes little time to carry out the work of the plate regeneration. Accordingly, it becomes possible to accomplish very swiftly the whole processes of printing.

Further, since the regeneration and reuse of the printing plate are made feasible, the amount of printing plate disposed after being put to use can be remarkably reduced. Accordingly, the method of regeneration and reuse of the printing plate can be environment protection oriented and it becomes possible to remarkably reduce the cost regarding the printing plate.

Furthermore, since the image writing to the printing plate can be directly implemented from the digital data concerning the image, this method can cope with digitization in the printing process. Accordingly, it becomes possible to remarkably reduce the time period required for the printing or decrease the cost.

While the first embodiment and the second embodiment of the present invention have been described above, the present invention is not limited to these embodiments but various modifications can be effected without departing the gist of the present invention.

For example, in the image deleting step, the surface of the photosensitive layer 3 is irradiated with the activating light as well as applied with heat. At this time, the image area requiring larger hydrophilizing energy than the non-image area may be heated at a higher temperature. In this way, the entire surface of the photosensitive layer 3 will be uniformly hydrophilized in a more reliable manner. Furthermore, in this case, the heat application to the region may be controlled based on the image data.

### [3]THIRD EMBODIMENT

As has been described in the aforesaid background art, the inventors of the present invention studied on a theme concerning the image writing and image deleting of the printing plate (layered formation) having the photosensitive layer, and during the studies, the inventors, confirmed that if the image writing was carried out with an activating light having a luminous flux density which could provide practical level of image writing rate, there could be a chance of temperature increase on the plate surface.

Then, the inventors. of the present invention aggressively studied a technology making it possible to remarkably and simultaneously improve a photocatalyst performance, or a performance for decomposing the organic compound even under the temperature increasing condition and a performance for hydrophilizing the photocatalyst itself. As a consequence, the inventors. finally found an indispensable factor that could improve these two performances even under the temperature increasing condition on the printing plate.

The technology thereof will be hereinafter described in detail as the third embodiment of the present invention with reference to the drawings and also the drawings used in the first embodiment.

The layered formation (as will be described later on, this structure can be utilized as the printing plate) 5 according to the third embodiment of the present invention is fundamentally composed of the substrate (or supporting body) 1, the intermediate layer (hereinafter referred to as a water retaining layer or hydrophilization promoting layer) 2 containing a substance having a water retaining function, and the photosensitive layer 3 containing the photocatalyst, as shown in FIG. 1.

That is, the layered formation 5 of the present embodiment has an arrangement different from that of the first embodiment in the intermediate layer 2.

As has been described in the description of the first embodiment, the substrate 1 is formed of a metal such as aluminum, stainless steel, and a polymer film or the like. However, the substrate 1 may not be necessarily formed of the metal such as aluminum, stainless steel, and a polymer film or the like, but other material may be selected depending on characteristics such as flexibility, hardness of the surface, thermal conductivity, electric conductivity, durability of the substrate which are considered to be necessary for bringing the photosensitive layer 3 into practical use. Further, characteristics to be taken into account upon selecting the material will not be limited to the above-listed characteristics.

The water retaining layer 2 as the intermediate layer is formed on the surface of the substrate 1. While in FIGS. 1 and 2 the intermediate layer 2 is formed so as to contact to the photosensitive layer 3, the intermediate layer is not necessarily contacted to the photosensitive layer but it is sufficient for the intermediate layer to be provided between the substrate 1 and the photosensitive layer 3.

As a substance having the water retaining function to be contained in the water retaining layer 2, silica type compound is particularly preferable. For example, this preferable compounds include a silica film, and a silica film precursor capable of forming silica film such as organic silicon compound and water glass, or silica fine particles and silica fine particle precursor capable of forming silica fine particles. If the substance having the water retaining function is fine particles, it is preferable for the fine particles to be formed into a film using a hydrophilic binder.

In order to achieve intimate contact between the substrate 1 and the water retaining layer 2, or to improve the intimacy in contact between the substrate 1 and the water retaining layer 2, an undercoat layer (not shown) may be provided between the substrate 1 and the water retaining layer 2 depending on necessity. If such an undercoat layer is provided, preferable material thereof includes a silicon type compound such as silica (SiO₂), silicon resin, silicon gum, for example. In particular, if a silicon resin is employed for the material, silicon alkyd, silicon urethane, silicon epoxy, silicon acryl, silicon polyester and the like are preferable.

When a heat treatment, which will be described later on, is effected for forming the photosensitive layer 3, an impurity diffusion tends to occur from the substrate 1 into the photosensitive layer 3 due to a thermal diffusion and be mixed therein, resulting in deterioration in the activity of the photocatalyst. However, the water retaining layer 2 exerts an effect for preventing such a thermal diffusion and resulting deterioration. Furthermore, if the water retaining layer 2 is formed of a polymer film or the like, the water retaining layer 2 exerts an effect for protecting the substrate 1.

Meanwhile, it was confirmed that even if the water retaining layer 2 is provided on the photosensitive layer 3, or alternatively, the photosensitive layer 3 has a substance having a water retaining function contained therein, the photocatalyst activity under the heated atmosphere was higher than the photocatalyst activity in the ordinary temperature.

However, if the water retaining layer 2 is provided on the photosensitive layer 3 or the photosensitive layer 3 is arranged to have a substance having a water retaining function contained therein, the rate of exposure of the photocatalyst on the surface thereof will be decreased. Therefore, as compared with the case of the present embodiment in which the water retaining layer 2 is provided as the intermediate layer between the substrate 1 and the photosensitive layer 3, the photocatalyst activity will be decreased.

Accordingly, if the layered formation 5 is formed so as to have a high photocatalyst activity in an ordinary temperature and further cohabitation is established on the substance having the water retaining function with the photocatalyst aiming at more improvement in the aforesaid photocatalyst activity under the heated atmosphere, as the present embodiment, it is obviously preferable for the photosensitive layer 3 to be provided as the uppermost layer (the most superficial layer) and for the water retaining layer 2 to be provided between the substrate 1 and the photosensitive layer 3.

In this way, the reason why the improvement is attained in the activity of the photocatalyst under the heated environment owing to the water retaining layer 2 provided between the substrate 1 and the photosensitive layer 3 can be assumed as follows.

That is, it is said that when the activating light is irradiated on the photocatalyst, the photocatalyst creates electrons and positive holes, which fact causes reaction of the positive holes with water absorbing molecules on the surface of the photosensitive layer 3, leading to creation of OH radicals (hydroxy radicals). Further, it is said that the OH radicals oxidize and decompose the organic compound.

Therefore, the amount of absorbed water will be ordinarily decreased under the heated atmosphere and also the amount of water molecules will be decreased. For this reason, shortage will be caused in the amount of water molecules necessary for generating the OH radicals. As a result, the amount of generated OH radicals are decreased and the performance of the photocatalyst for decomposing the organic substance will be lowered.

Thus, the substance having the water retaining function is provided near the photocatalyst in a cohabitation manner so that sufficient water molecule supply will be ensured from the substance having the water retaining function to the photocatalyst under the heated atmosphere. With this arrangement, a plenty of OH radicals are generated and the oxidization and decomposition reaction is promoted owing to the heat application. As a result, it is assumed that the performance of organic compound decomposition is improved.

As described above, if the photocatalyst action is improved under the heated atmosphere and the layered formation 5 having the photosensitive layer 3 is utilized as the printing plate, it becomes possible to decrease the irradiation energy (hereinafter referred to as hydrophilization energy) required for converting the hydrophobicity into hydrophilicity owing to the heat application to the activating light irradiated portion when the activating light is irradiated onto the plate surface upon the image writing, and also owing to the heat application to the plate surface with the energy deriving from the activating light itself.

With this consequence, it becomes possible to shorten the time period required for the writing and fabricating the plate and decrease the output power of the imaging unit to reduce the cost of the writing unit. Also, when the image of the plate surface is deleted, the temperature rise of the plate surface and the activating light irradiation can be effected simultaneously to decrease the irradiation energy of the activating light required for deleting the image. Accordingly, it becomes possible to shorten the time period required for deleting the image or decrease the output power of the image deleting unit (i.e., decrease the cost of fabrication).

The photosensitive layer 3 is provided on the water retaining layer 2. If the activating light irradiated onto the surface of the photosensitive layer 3 has an energy level higher than the band gap energy of the photocatalyst, then it is expected that the organic compound attached to the surface of the photosensitive layer 3 is decomposed, and at the same time the photocatalyst itself exhibits a high hydrophilicity.

The photosensitive layer 3 may be added with the following substances for the seek of preservation of hydrophilic characteristic and improvement in strength of the photosensitive layer 3 and intimate contact of the photosensitive layer with the water retaining layer 2. Such a kind of substances include, for example, a silica type compound such as silica, silica sol, organosilane, silicon resin, a metal oxide material such as zirconium, aluminum, titanium, or a fluoric resin.

Further, the layered formation may have a modified arrangement such that a photosensitive layer 3 responsive to light having a wavelength of 380 nm or less (not shown) is additionally provided as a protection layer or that a silica layer (not shown) is provided for attaining easier preservation of the hydrophilicity. The photosensitive layer 3 according to the present invention conceptually includes the above-arranged layers. Further, the photosensitive layer 3 may be a layer formed of a single component of photocatalyst.

As described above, according to the present invention, the layered formation 5 having the photosensitive layer 3 can be fundamentally utilized as the printing plate. If aluminum is employed as the substrate 1, for example, the surface thereof may be subjected to a so-called gray treatment in which the surface is made coarse by means of an anode oxidation treatment or the like upon necessity. With this treatment, the layered formation will have more improved function suitable for the printing. Consequently, the layered formation 5 having the aforesaid photosensitive layer 3 can be directly utilized as the printing plate, and also the layered formation having the substrate 1 undergone the aforesaid gray treatment may be utilized as the printing plate.

Moreover, the layered formation according to the present invention exhibits a remarkably higher photocatalyst activity in the heated atmosphere than in the room temperature. Therefore, if the aforesaid layered formation 5 is employed for a surface layer of a structure utilized under a heated atmosphere such as a chimney, in particular, the photocatalyst will decompose the organic compound contained in dirt components. Furthermore, since the photocatalyst will exhibit a high hydrophilic nature, a dirt component of an organic compound which is incapable of being decomposed by the photocatalyst will be washed off with rain drops. Accordingly, the outer wall surface can be protected from being smeared.

Further, if the layered formation 5 is employed for the printing plate, the organic compound for hydrophobizing the photosensitive layer 3 is desired to be a type of organic compound. That is, the organic compound can be supplied to the printing plate surface (plate surface), and also the organic compound is desired to have a nature responsive to merely the drying or the drying with heat application if necessary, so as to cause reaction or strong interaction with the plate surface, i.e., the surface of the photosensitive layer 3, so that the surface of the photosensitive layer 3 can be hydrophobized. Also, the organic compound is desired to have a nature to be decomposed owing to the action of the photocatalyst and removed from the surface of the photosensitive layer 3 (i.e., the type A organic compound described in the description of the first embodiment). While description will not be provided in that of the present embodiment, as has been described in that of the second embodiment, it is needless to say that the type B organic compound may be employed for hydrophobizing the photosensitive layer 3.

The method of fabricating the plate and the method of regenerating the same when the layered formation 5 of the present invention is applied to the printing plate are similar to those described in that of the first embodiment. Therefore, they will not be described.

In the subject embodiment, if the plate surface can be heated by only the irradiation of the activating light utilized upon writing an image and it is ensured to raise the temperature of the plate surface up to a proper one which enables the image writing to be carried out swiftly, particular heating means need not be prepared.

Further, if the photocatalyst characteristic is converted from hydrophilic to hydrophobic for recovering the “initial state of plate fabrication”, in addition to the applying of the organic compound capable of interacting with the plate surface to the plate surface, other operation may be effected. For example, a bundle of energy beams such as of light beams and electric beams may be solely or in combination fashion irradiated onto the plate surface or any mechanical stimulation such as rubbing may be applied to the plate surface to hydrophobize the same.

Now description will be hereinafter made on more concrete embodiments and compared examples concerning the production of the printing plate 5, the plate-making and plate regeneration which were confirmed by the inventors of the present application.

### [A] EMBODIMENT

(1) Photocatalyst Preparation

Titanium sulfate as a raw material (Wako Pure Chemical Industries, Ltd.) was prepared and this agent was added with ammonium water by stirring the mixture. Thus, a hydrolysis of the titanium sulfate was obtained. This hydrolysis was filtered by using a suction funnel and washed by ion-exchange water until the filtered liquid came to have an electric conductivity equal to or smaller than 2 μS/cm. After the washing, the hydrolysis was dried at a room temperature and then burned for two hours at 400° C. in the atmosphere. The burned material was reduced to coarse grain in a mortar to obtain a photocatalyst powder.

(2) Confirmation of Activity by Visible Light

The above-described photocatalyst powder was picked up by 0.2 g and uniformly spread on a bottom of a cylindrical reaction vessel (volume 500 ml) made of Pyrex (registered trademark) glass. Then, the reaction vessel is evacuated and the inner air is substituted with highly purified air. Thereafter, acetone was poured into the vessel so that the concentration thereof within the reaction vessel became 500 ppm. Then, the powder was left at a temperature of 25° C. in a dark place for ten hours until the adsorption of the powder reached an adsorption equilibrium. Thereafter, light (main wavelength of 470 nm) was irradiated onto the powder by using a blue LED produced by NICHIA chemical industry. Then, the amount of acetone and CO₂ were measured by a gas chromatograph produced by Shimadzu Corp. This measurement reveals that there was no acetone found after irradiation by the blue LED for 20 hours, and instead of this vanishment of acetone, generation of CO₂ of which stoichiometric ratio corresponded to that of acetone was confirmed. That is, it is successfully confirmed that the aforesaid photocatalyst powder exhibits the photocatalyst activity with the light having the wavelength of 470 nm.

(3) Production of Printing Plate

(3-1) Preparation of Photocatalyst Dispersion Liquid and Base Plate 1

The above-described photocatalyst powder was dispersed within an ion-exchange water to produce a slurry having a 20 weight percent (wt %) of solid body component. This slurry was added with polycarboxylic acid of 1 wt % relative to the photocatalyst. Thereafter, this slurry was reduced to powder by a wet mill (trade name: DAINO mill PILOT) to obtain the photocatalyst dispersed liquid.

A substrate 1 made of a stainless steel plate (SUS 301) having an area of 280×204 mm and thickness of 0.1 mm was prepared and this plate was subjected to an alkali degrease processing to obtain the substrate 1.

(3-2) Formation of Water Retaining Layer

A water glass LSS-35 containing Li₂O (Nissan Chemical Industries, Ltd.) was diluted with distilled water so that the solid component of SiO₂ becomes 5 wt %. Thus the SiO₂ coating liquid was prepared. This SiO₂ coating liquid was dip coated on the aforesaid base plate 1 and the base plate was dried by air drying. Thereafter, the base plate was baked for one hour at a temperature of 500° C. to form the SiO₂ water retaining layer 2. The thickness of the SiO₂ water retaining layer 2 was about 0.12 μm.

(3-3) Formation of Photosensitive Layer 3

The aforesaid photocatalyst dispersion liquid and the titanium oxide coating agent TKC-301 produced by TAYCA Corporation were mixed with each other at a ratio of 6:4 as TiO₂, and the resulting liquid was dip coated on the base plate 1 having the aforesaid SiO₂ water retaining layer 2 coated thereon and the base plate was dried by air drying. Thereafter, the base plate was baked for one hour at a temperature of 350° C. to form the photosensitive layer 3. Thus, the printing plate 5 was prepared. The thickness of the photosensitive layer 3 was about 0.1 μm. The contact angle of water 6 on the plate surface was measured by using a CA-W type contact angle meter manufactured by Kyowa Kaimen Kagaku Co., Ltd., and a contact angle of 8° was obtained. This measurement proved that satisfactory hydrophilicity was achieved.

(4) Hydrophobization of Plate Surface

Subsequently, 1,2-epoxy dodecane (Wako Pure Chemical Industries, Ltd.) was dissolved in isoparaffin (trade name: Isoper L, a product of Exxon Mobile Co.) to obtain 1 wt % solution thereof. This 1,2-epoxy dodecane solution was roll-coated on the printing plate surface and the printing plate is dried for ten minutes at a temperature of 60° C. Thereafter, the contact angle of water 6 was measured by the aforesaid contact angle meter, and a contact angle of 83° was obtained. This measurement proved that the plate exhibited satisfactory hydrophobicity and it was confirmed the surface of the printing plate 5 was brought to the initial state of plate fabrication.

(5) Measurement of Hydrophilization Energy Variation with Change in Plate Surface Temperature

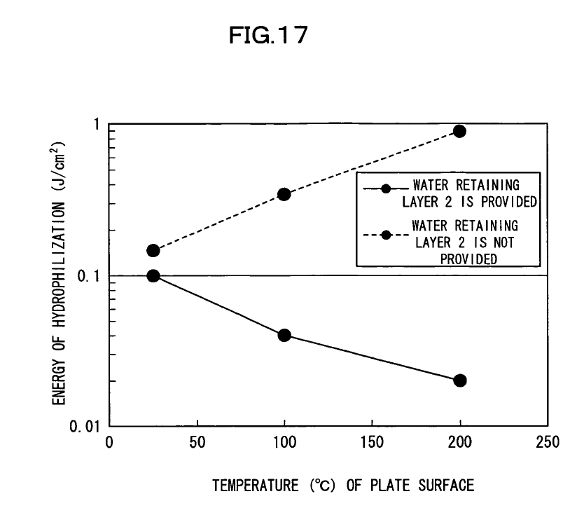

The variation of the hydrophilization energy with the change in plate surface temperature was measured in such a method that, the surface temperature of the aforesaid hydrophobized printing plate 5 was changed, an activating light having a wavelength of 360 nm and a luminous flux density of 10 mW/cm² was irradiated on the printing plate, and the hydrophilization energy was determined by calculating a product of the luminous flux density of the activating light and a time period of the activating light irradiation required for changing the state of the plate surface from the hydrophobized state as described above to the state in which the contact angle exhibits 100 or less. FIG. 17 is a graph showing the result of the measurement.

As shown with a solid line in FIG. 17, if there is provided the water retaining layer 2 (TiO₂ photosensitive layer 3/SiO₂ water retaining layer 2/stainless steel base plate 1), the hydrophilization energy at the plate surface temperature of 25° C. was 0.1 J/cm². When the plate surface temperature was 100° C., the hydrophilization energy was 0.04 J/cm², and the plate surface temperature was 200° C., the hydrophilization energy was 0.02 J/cm². As will be understood from these result of measurement, higher the plate surface temperature was increased, smaller the hydrophilization (activating light irradiation energy required for hydrophilization) energy became.

(6) Image Writing

Subsequently, a UV-Setter 710 released from basysPrint Corporation (Germany) generating a ultraviolet light having a wavelength of 360 nm to 450 nm and capable of writing an image (non-image area) was utilized for writing a halftone images with a printing element rate varying from 10% to 100% at a step of 10%. When the image writing was executed, irradiation of an infrared light was effected on the plate surface 0.1 second before the image writing with the activating light, thereby to raise the temperature of the plate surface instantly up to about 240° C. Thus, the temperature of the plate surface upon writing an image with the activating light was conditioned to one slightly exceeding a temperature of 200° C. Under this condition, the image writing was executed. Since adjustment was made for the luminous flux density to have 200 mW/cm² when the UV-Setter 710 irradiates the light having the wavelength of 360 nm on the plate surface, the time period of the activating light irradiation for a unit area was set to 0.02 J/cm² as the irradiation energy.

Since the size of the unit area is 17 mm×13 mm, it took 24 sec. for writing the image on the plate surface having a size of 280 mm×204 mm (the image area has a size of 272 mm×195 mm). The water contact angle of the printing plate surface after completing the writing step was measured by the aforesaid contact angle meter. It was confirmed that the contact angle of water 6 at a portion on which an image was written was 80 and this portion became a hydrophilic non-image area while the contact angle at a portion on which no image was written was 830 and this portion became an image area keeping the hydrophobic nature.

(7) Printing

This printing plate was set on the desktop offset printing press “NEW ACE PRO” manufactured by Alpha Techno Company, printing was performed on AIBESTO paper with an ink HYECOOB Red MZ manufactured by Toyo Ink Manufacturing Co., Ltd. and dampening water, a 1% solution of LITHOFELLOW manufactured by Mitsubishi Heavy Industries, Ltd. at a printing speed of 3500 sheets/hour. The halftone image was successfully printed on from a first sheet of paper fed at the start of printing.

(8) Regeneration

An embodiment according to the plate regeneration will be hereinafter described.

After the printing was completed, the ink, the dampening water, the paper dust and the like attached to the plate surface were cleanly wiped off. Then, an infrared light was irradiated on the entire surface of the plate so as to heat the plate surface instantly up to a temperature of about 100° C. Under this condition, an ultraviolet light having a wavelength of 360 nm and a luminous flux density of 5 mW/cm² was irradiated for eight seconds (0.04 J/cm² as the irradiated energy). Thereafter, the contact angle of water 6 was immediately measured by using the aforesaid contact angle meter at a portion on which the halftone image was written, and a contact angle of 80° was obtained. This measurement proved that the plate surface exhibited a satisfactory hydrophilicity and hence it was confirmed that the image of the plate could be deleted.

Subsequently, aforesaid 1,2-epoxy dodecane solution was roll-coated on the plate surface and the plate is dried for ten minutes at a temperature of 60° C. Thereafter, the contact angle of water 6 was measured by the aforesaid contact angle meter, and a contact angle of 84° was obtained. This measurement proved that the plate exhibited satisfactory hydrophobicity and it was confirmed the printing plate 5 was brought to the “initial state of plate fabrication” and the plate regeneration was accomplished.

### [B] COMPARED EXAMPLE

The printing plate was produced in a manner similar to that of the aforesaid embodiment except for that the photosensitive layer 3 was provided directly on the stainless steel substrate 1. That is, the printing plate was produced without the water retaining layer 2.

The variation of the hydrophilization energy with the change in plate surface temperature was measured on the printing plate as the compared example in a manner similar to that of the above embodiment. FIG. 17 is a graph showing the result of the measurement.

As shown with a dotted line in FIG. 17, if there is no water retaining layer 2 provided (TiO₂ photosensitive layer 3/stainless steel base plate 1), the hydrophilization energy at the plate surface temperature of 25° C. was 0.15 J/cm². When the plate surface temperature was 100° C., the hydrophilization energy was 0.35 J/cm², and the plate surface temperature was 200° C., the hydrophilization energy was 0.9 J/cm². As will be understood from the result of measurement, higher the plate surface temperature was raised, larger was the hydrophilization (activating light irradiation energy required for hydrophilization) energy requested.

Further, similarly to the above embodiment, the aforesaid UV-Setter 710 was utilized to carry out image writing at a light exposure time of 0.1 second per unit area (the total time period for writing the image was 24 sec.). After the image writing was completed, the contact angle of water 6 on the plate surface was measured by the aforesaid contact angle meter. The measurement revealed that the contact angle of the portion on which the image was written was 68° and this portion still maintained a high hydrophobicity. Similarly to the aforesaid embodiment, this plate was set on the desktop offset printing press “NEW ACE PRO” manufactured by Alpha Techno Company, printing was performed on AIBESTO paper with an ink HYECOOB Red MZ manufactured by Toyo Ink Manufacturing Co., Ltd. and dampening water, a 1% solution of LITHOFELLOW manufactured by Mitsubishi Heavy Industries, Ltd. at a printing speed of 3500 sheets/hour. The inspection on the resulting printed paper revealed that even a portion expected to be the non-image area failed to repel the ink and an only achievement was a so-called “solid” printing in which the entire surface of the plate was filled with the red ink.

The above-described printing and regeneration of the plate can be carried out by using the printing press 10 (see FIG. 8) which has been described together with the first embodiment. Also, in this case, the hydrophobizing unit 14 for the plate surface is constructed as a unit which can perform any of the operations, i.e., to irradiate a bundle of energy beams such as of light beams and electric beams solely or in combination fashion onto the plate surface, to apply any mechanical stimulation such as rubbing to the plate surface, or to supply to the plate surface an organic compound capable of causing interaction with the plate surface.

As described above, according to the layered formation 5 as the present embodiment, the intermediate layer (water retaining layer) 2 containing a substance having a water retaining function is provided between the substrate 1 and the photosensitive layer 3. Therefore, the activity of the photocatalyst under the heated atmosphere can be remarkably improved and the surface of the photosensitive layer 3 can be hydrophilized swiftly.

Therefore, if the above-described layered formation 5 is applied to the printing plate, the following advantages can be obtained in addition to the advantage that the printing plate can be reused. That is, since the image writing with the activating light can be executed under heated atmosphere, the time period required for the image writing can be shortened. Alternatively, since the irradiated energy of the activating light required for the hydrophilization can be made small, even a writing unit capable of generating only a small output power can be utilized, and hence the cost of unit can be decreased.

Further, since the image on the plate surface can be deleted by irradiating the activating light under the heated atmosphere, the time period required for the image deleting can be shortened. Alternatively, similarly to what set forth above, since the irradiated energy of the activating light required for the hydrophilization can be made small, even an image deleting unit capable of generating only a small output power can be utilized, and hence the cost of unit can be decreased.

As described above, since the photocatalyst can be activated under the heated atmosphere, if the surface of the photosensitive layer 3 can be converted (switched) from the hydrophobic to hydrophilic in its characteristic, working time can be saved even in the step of plate fabrication and the step of image deletion during the plate regeneration process after the printing, with the result that the cycle of plate-making and plate regeneration can be swiftly accomplished.

Moreover, light having a wavelength of 600 nm or less including a visible light can be utilized as the activating light. Therefore, the visible light can be employed for the image writing and image deleting, which fact makes it easy to handle the printing plate.

1-27. (canceled)

28. A printing plate (5, 35) having a photosensitive layer (3) containing a photocatalyst which makes it possible to carry out image writing and image deleting in response to irradiation of an activating light having an energy level higher than the band gap energy of said photocatalyst, thereby to regenerate the printing plate for allowing reuse of the printing plate,
said printing plate characterized by comprising a hydrophilization promoting layer (2) for promoting the hydrophilization provided between a substrate (1) and said photosensitive layer (3).

29. A printing plate according to claim 28, characterized in that said hydrophilization promoting layer (2) contains a substance having a water retaining property.

30. A printing plate according to claim 29, characterized in that said substance having the water retaining property is a silica compound.

31. A printing plate according to claim 28, characterized in that said photocatalyst is a titanium dioxide photocatalyst or a visible light responsive type titanium dioxide photocatalyst.

32. A printing plate according to claim 28, characterized in that when said activating light is irradiated to effect image writing and image deleting, at least a part of the surface of said photosensitive layer (3) is converted from a hydrophobic nature to a hydrophilic nature.

33. A printing plate according to claim 28, characterized in that said activating light is one having a wavelength of 600 nm or below.

34. A printing plate according to claim 28, characterized in that the surface of said photosensitive layer (3) is hydrophobized by anyone of actions that a bundle of light beams or electric energy beams is solely or in combination fashion applied onto the surface of said photosensitive layer (3), friction is applied on the surface of said photosensitive layer (3), or an organic compound capable of effecting interaction with the surface of said photosensitive layer (3) is supplied to the surface of said photosensitive layer (3).

35. A method of fabricating a printing plate (5, 35) according to claim 28, characterized by comprising a step of:
forming said hydrophilization promoting layer (2) on said substrate (1) and thereafter forming said photosensitive layer (3) on said hydrophilization promoting layer (2).

36. A layered formation (5, 35) having a photosensitive layer (3) containing a photocatalyst, said layered formation exhibiting simultaneously two performances, a performance making it possible to decompose an organic compound provided on the surface of said photosensitive layer (3) and a performance making it possible to hydrophilize the surface of said photosensitive layer (3) in response to an irradiation of an activating light having an energy level higher than the band gap energy of said photocatalyst, said layered formation characterized in that a water retaining layer (2) containing a substance having a water retaining property is provided between a substrate (1) and said photosensitive layer (3).

37. A layered formation according to claim 36, characterized in that said substance having the water retaining property is a silica compound.

38. A layered formation according to claim 36, characterized in that said photocatalyst is a titanium dioxide photocatalyst or a visible light responsive type titanium dioxide photocatalyst.

39. A method of fabricating a layered formation (5, 35) according to claim 36, characterized by comprising a step of:
forming said water retaining layer (2) on said substrate (1) and thereafter forming said photosensitive layer (3) on said water retaining layer (2).

40. A method of regenerating a printing plate (5, 35) for allowing reuse of the printing plate (5, 35) according to claim 28, characterized by comprising steps of:
removing ink remaining on the surface of said photosensitive layer (3);
deleting an image of the surface of said photosensitive layer (3) in such a manner that said activating light is irradiated onto said surface of said photosensitive layer (3) having the ink removed therefrom in said step of removing ink and said photosensitive layer (3) is heated so as to make the entire surface of said photosensitive layer (3) hydrophilic; and
applying organic compound onto the surface of said photosensitive layer (3) having the image deleted in said step of deleting said image.

41. A method of regenerating a printing plate according to claim 40, characterized in that, in said step of applying organic compound, said photosensitive layer (3) is supplied on the surface thereof with an organic compound which has a nature that the organic compound is decomposed in response to said activating light irradiation owing to the action of said photocatalyst and a nature that the organic compound hydrophobizes the surface of said photosensitive layer (3) owing to the reaction and/or interaction with said surface of the photosensitive layer (3).

42. A method of regenerating a printing plate according to claim 40, characterized in that, in said step of applying organic compound, said photosensitive layer (3) is supplied on the surface thereof with an organic compound which has a nature that the organic compound is decomposed in response to said activating light irradiation owing to the action of said photocatalyst and a nature that the organic compound melts by heat application to be formed into a film-like shape and hydrophobizes the surface of said photosensitive layer (3) owing to the reaction and/or interaction with said surface of the photosensitive layer (3) or fixing on the surface of said photosensitive layer (3).

43. A method of regenerating a printing plate according to claim 40, characterized in that, in said step of deleting the image, the surface of said photosensitive layer (3) is heated up to a temperature range of at least 50° C. and below 200° C.

44. A method of regenerating a printing plate according to claim 40, characterized in that, in said step of deleting the image, the heat application is effected by applying hot air to the surface of the photosensitive layer (3).

45. A method of regenerating a printing plate according to claim 40, characterized in that, in said step of deleting the image, the heat application is effected by irradiating light onto the surface of the photosensitive layer (3).

46. A method of regenerating a printing plate according to claim 40, characterized in that said activating light is one having a wavelength of 600 nm or below.

47. A method of regenerating a printing plate according to claim 40, characterized in that said photocatalyst is a titanium dioxide photocatalyst or a visible light responsive type titanium dioxide photocatalyst.

48. A regenerating apparatus characterized by comprising:
a plate cylinder (11) having attached thereon a printing plate (5, 35) according to claim 28;
a plate cleaning unit (12) for removing ink coated on the surface of said photosensitive layer (3);
an image deleting unit (16) for irradiating said activating light on said photosensitive layer (3) after removing said ink so as to make the entire surface of said photosensitive layer (3) hydrophilic and delete the image on the surface of the photosensitive layer (3);
a heating unit (15) for heating the surface of said photosensitive layer (3) to promote the hydrophilization upon deleting said image; and
an organic compound applying unit (14) for applying an organic compound onto the surface of said photosensitive layer (3).

49. A regenerating apparatus according to claim 48, characterized in that said heating unit (15) heats the surface of the photosensitive layer (3) by an electric heater.

50. A regenerating apparatus according to claim 48, characterized in that said heating unit (15) heats the surface of the photosensitive layer (3) by irradiating light.

51. A regenerating apparatus according to claim 48, characterized in that said organic compound applying unit (14) applies to the surface of said photosensitive layer (3) an organic compound which has a nature that the organic compound is decomposed in response to said activating light irradiation owing to the action of said photocatalyst and a nature that the organic compound hydrophobizes the surface of said photosensitive layer (3) owing to the reaction and/or interaction with said surface of the photosensitive layer (3).

52. A regenerating apparatus according to claim 48, characterized in that said organic compound applying unit (14) applies to the surface of said photosensitive layer (3) an organic compound which has a nature that the organic compound is decomposed in response to said activating light irradiation owing to the action of said photocatalyst and a nature that the organic compound melts by heat application to be formed into a film-like shape and hydrophobizes the surface of said photosensitive layer (3) owing to the reaction and/or interaction with said surface of the photosensitive layer (3) or fixing on the surface of said photosensitive layer (3).

53. A printing press characterized by comprising:
the regenerating apparatus according to claim 51; and
an imaging unit (13) for irradiating an activating light onto the surface of said photosensitive layer (3) covered with a hydrophobic organic compound to decompose and remove said hydrophobic organic compound, exposing the surface of the hydrophilic photosensitive layer (3), and writing an image on the surface of the hydrophilic photosensitive layer (3).

54. A printing press characterized by comprising:
the regenerating apparatus according to claim 52; and
an imaging unit (13) for irradiating an inactive light for the photocatalyst to bring said image area into a reaction and/or an interaction with the surface of said photosensitive layer (3) so that the organic compound is fixed thereon, whereby an image is written on the surface of the photosensitive layer (3).
